(19) United States
(12) Patent Application Publication
(10) Pub. No.: US 2023/0060028 A1
(43) Pub. Date: Feb. 23, 2023

(54) SYSTEMS AND METHODS FOR THE PRODUCTION OF HYDROGEN AND CARBON

(71) Applicant: Torrent Energy, Gardena, CA (US)

(72) Inventors: Richard W. JARVIS, West Palm Beach, FL (US); George Z. PASKALOV, Torrance, CA (US); Brian K. HARMISON, Oak Hill, VA (US); Alexandr USTIMENKO, Almaty (KZ); Alfred Lvovich MOSSE, Minsk (BY); Vladimir MESSERLE, Almaty (KZ)

(73) Assignee: Torrent Energy, Gardena, CA (US)

(21) Appl. No.: 17/891,418

(22) Filed: Aug. 19, 2022

Related U.S. Application Data
(60) Provisional application No. 63/235,025, filed on Aug. 19, 2021.
(60) Provisional application No. 63/242,273, filed on Sep. 9, 2021.

(51) Int. Cl. C01B 3/24

(52) U.S. Cl. CPC C01B 3/24; C01B 2203/049; C01B 2203/0861; C01B 2203/0883; C01B 2203/1235

(57) ABSTRACT

A method for producing hydrogen and carbon from hydrocarbons in a reaction chamber is provided. The method includes introducing a hydrocarbon into a chamber such that the hydrocarbon rotates in a first direction. The method includes generating a direct current (DC)-based plasma from a portion of the hydrocarbon, wherein the hydrocarbon is heated to a temperature greater than 1,000° C. at least in part by the DC-based plasma. The method includes rotating the DC-based plasma in a second direction that is different from the first direction. The method includes converting the hydrocarbon into elemental constituents of the hydrocarbon comprising carbon solid and hydrogen gas. The method includes separating the carbon solid from the hydrogen gas to provide a solid part and a gas part.

### CROSS-REFERENCE TO RELATED PATENTS

This application claims priority to U.S. Provisional Application No. 63/235,025, filed Aug. 19, 2021 and titled Systems and Methods for the Production of Hydrogen and/or Carbon; and U.S. Provisional Application No. 63/242,273 filed Sep. 9, 2021 and titled Systems and Methods for the Production of Hydrogen from Liquids, Oils, Semi-Solid Hydrocarbons, the disclosures of each of which is hereby incorporated by reference in entirety.

### TECHNICAL FIELD

Disclosed are embodiments related to systems and methods for the production of hydrogen and/or carbon black, including through utilization of plasma-induced decomposition of hydrocarbon feedstocks. The embodiments disclosed herein relate to hydrogen production systems and methods, utilizing all kinds of liquid, oil, and semi-solid hydrocarbons for primary feedstock, and gaseous hydrocarbons for plasma-based high heat decomposition.

### BACKGROUND

Various devices and processes have been utilized over the years to break hydrocarbons down into their constituent elements, namely, hydrogen and carbon. The uses for these byproducts vary widely. For example, hydrogen has an array of uses in various sectors including, but not limited to, the industrial and transportation sectors. As hydrocarbons are broken down into their constituent elements, the result may include syngas, which contains hydrogen. In some embodiments, the syngas is further processed to separate the hydrogen.

The carbon byproduct has a number of uses as well, including when the carbon byproduct is processed as carbon black, which is a form of para-crystalline carbon that has a high surface-area-to-volume ratio. Carbon black can be used for a number of applications including tires, hoses, belts, pipes, inks, batteries, plastics, and other products where black color is required.

Traditional prior art devices and processes utilized to decompose hydrocarbons into hydrogen and carbon include stream methane reforming (SMR) and polymer electrolyte membrane (PEM) cells. SMR is a method for producing syngas (hydrogen and carbon monoxide) by the reaction of hydrocarbons with water (as steam), and emits significant amounts of carbon dioxide (CO₂), e.g., about 3-10 kg CO₂ per kg of produced hydrogen. PEM cells can also be used to decompose hydrocarbons from methanol and similarly emit significant amounts of CO₂, e.g., about 1-3 kg CO₂ per kg of produced hydrogen. Further, traditional prior art devices and processes are limited to about 70% of the hydrocarbon gas input being disassociated, that is, traditional prior art devices and processes were at most 70% efficient in creating hydrogen and carbon from hydrocarbon gas input.

Such processes are very polluting and include the release of many metric tons of greenhouse gases each year. The processes are also not efficient in that each require a significant amount of energy to produce a kilogram (kg) of hydrogen.

Light and heavy residual refinery oils, semi-solids, and natural gas, have long been a resource for the production of hydrogen and carbon, such as through the process of dissociating the hydrocarbon molecules into carbon and hydrogen in the presence of water for hydrogen, and from partial gasification with water quenching for carbon black. When processing these hydrocarbon-containing materials (such as refinery oils, semi-solids, and natural gas), the hydrocarbon-containing materials have typically been used as an energy source for the production of hydrogen and carbon.

### SUMMARY

Because of the high temperatures involved in the processes for producing hydrogen and carbon from hydrocarbon-containing materials, the high flow rates used for both energy and feedstock, and the difficulties involved with trying to control the properties of products resulting from such complex processes, methods and apparatus for producing such products in more efficient and effective ways, requiring less energy, and improving the properties of the products produced are needed. Further, methods and apparatus for producing such products without the significant amount of CO₂ emission, or other pollution, are needed. Further, methods for the production of hydrogen and carbon from oils, lubricants, waste oils, and semi-solids is unique to the industry and needed so that these wastes are not sold and burned for heat emitting vast quantities of CO₂. It is noted that about 80% of recycled oils are not recycled, but simply filtered and burned. The embodiments shown and described herein represent an advancement over the prior art through utilization of plasma and other system elements to produce hydrogen and high-grade carbon black from various feedstocks in an energy-efficient and environmentally friendly manner, utilizing plasma energies directly into these feedstocks. Embodiments are able to produce hydrogen and/or carbon with significantly less CO₂ emission, or other pollution, than prior methods, and in embodiments may do so without any CO₂ emission, or other pollution, generated from processing of the hydrocarbon-containing gas as a plasma source without oxygen and transmitting directly that high energy as heat into liquids and semi-solids. Embodiments are able to disassociate substantially more than 70% of the hydrocarbons, both gas and liquid (where prior art devices do not accomplish this in liquids), and in embodiments achieve a disassociation rate of more than 98%, up to substantially 100% (e.g., 99.99%).

Embodiments herein describe processes and apparatus for generating hydrogen and carbon (e.g., carbon powder) by disassociating methane and other hydrocarbons through the utilization of a system that utilizes, among other things, a plasma discharge and reaction chamber. In embodiments, a hydrocarbon gas is introduced into the reaction chamber in an angular manner such that the hydrocarbon gas rotates within the chamber and comes into rotational contact with a plasma that has been created within the chamber. In some embodiments, the plasma also rotates within the chamber at high rotational speed and in a different (e.g., opposite) direction compared to the rotation of the hydrocarbon gas, as regulated by electrical current controlled magnets.

In some embodiments, the plasma and hydrocarbon gas are caused to rotate in opposing directions. The relative angular rotation of the gas and plasma results in the increased occurrence of the plasma coming into contact with the gas and dissociating the hydrocarbon into its elemental components of hydrogen and carbon, and processes are provided for separating and refining the resulting products, such as quenching to produce carbon black. Different plasma technologies may also be used, including, for example, a DC plasma, or a combination of DC and RF plasma.

Embodiments can be realized as a small modular unit. Accordingly, these small modular units may be placed on mobile transportation (e.g., ships) to process while they are moving or process at the point of unloading, having the advantages described herein. A conversion ship (containing hydrocarbon disassociation systems as described herein), being at sea, will not need to expend the energy to produce the additional cooling water/fluid required for the process of conversion, and may simply pump in and drain out all the cooling fluid that is needed. This is a large energy savings and a large reduction in emissions released.

Advantages include the following. Hydrogen, being so light, is expensive to transport, even if liquid. Countries that want to advance their hydrogen economies past the emissions of using hydrocarbon fuels and don't have the resources to produce this clean burning fuel at an economic level that is affordable, and practical, will have the option of still purchasing liquid natural gas (“LNG”), an existing resource and transportation infrastructure, and convert the LNG to H₂ after the expense of the most efficient transportation is done, and at the point where large volume storage is most advantageous.

Since the carbon produced by the fuel conversion needs to be removed and this carbon is completely inert, it could be collected and also sold if the receiving client wishes to process it further on-shore, or it could be dumped overboard. There will be future discoveries and uses of this material making it desirable to recover.

By producing the power onboard a ship in some embodiments for the conversion process, different regulations apply to electrical generation on a ship at sea, versus land-based electrical generation. The method proposed would use the re-gasified LNG as natural gas in gen-sets on the conversion ship, a much cleaner option than diesel or bunker fuels.

Further advantages of embodiments are operating and feedstock-costs, which are improved by using plasma to cause disassociation in the manner described herein. Embodiments are also efficient, so that they can get the most out of every kilowatt used to process the feedstock to product conversion. Embodiments enhance the productivity and efficiency of the dissociation process beyond known methods.

According to a first aspect, a method for producing hydrogen and carbon from hydrocarbons in a reaction chamber is provided. The method includes introducing a hydrocarbon into a chamber such that the hydrocarbon rotates in a first direction. The method includes generating a direct current (DC)-based plasma from a portion of the hydrocarbon, wherein the hydrocarbon is heated to a temperature greater than 1,000° C. at least in part by the DC-based plasma. The method includes rotating the DC-based plasma in a second direction that is different from the first direction. The method includes converting the hydrocarbon into elemental constituents of the hydrocarbon comprising carbon solid and hydrogen gas. The method includes separating the carbon solid from the hydrogen gas to provide a solid part and a gas part.

According to a second aspect, an apparatus for producing hydrogen and carbon solid from gaseous hydrocarbons is provided. The apparatus includes a processing chamber having a gas input, a gas outlet, and a solid outlet. The apparatus includes a direct current (DC) plasma generator configured to generate a plasma within a plasma processing zone of the processing chamber, wherein the DC plasma generator includes a cathode and anode within the processing chamber and wherein the DC plasma generator is configured so that the plasma heats up gas passing through the plasma processing zone to a temperature greater than 1,000° C. causing hydrocarbons in the gas to disassociate. The apparatus includes a magnet external to the processing chamber configured to cause plasma generated by the DC plasma generator to rotate. The apparatus includes a cooling system within a separating zone of the processing chamber, wherein the gas input is configured to cause gas that passes through the gas input to rotate.

According to a third aspect, an apparatus for producing hydrogen and carbon solid from gaseous hydrocarbons is provided. The apparatus includes a processing chamber having a gas input, a gas outlet, and a solid outlet. The apparatus includes a plasma generator configured to generate a plasma within a plasma-processing zone of the processing chamber and wherein the DC plasma generator is configured so that the plasma heats up gas passing through the plasma processing zone to a temperature greater than 1,400° causing hydrocarbons in the gas to disassociate. The apparatus includes a magnet external to the processing chamber configured to cause plasma generated by the DC plasma generator to rotate. The apparatus includes a cooling system within a separating zone of the processing chamber; wherein the cooling system is capable of reducing a gas temperature to about 500° C. (or 1,000° C.) or less so as to stop carbon black particle, aggregate, and agglomerate formation.

According to a fourth aspect, a method for producing hydrogen and carbon solid from liquid hydrocarbons is provided. The method includes introducing liquid hydrocarbons to a processing vessel. The method includes introducing a plasma-forming gas. The method includes forming or maintaining a DC plasma discharge between a cathode and an anode based at least in part on the plasma-forming gas, wherein the anode is rotatable and is at least partially submerged in the liquid hydrocarbons. The method includes rotating the anode to form a liquid film covering the anode, so that hydrocarbons in the liquid film are heated by the DC plasma discharge to a temperature in the range between 1500 degrees K and 6000 degrees K thereby converting at least part of the hydrocarbons in the liquid film into elemental constituents. The method includes cooling the constituents to form a gas and solid product mixture comprising hydrogen gas and carbon solid. The method includes extracting the hydrogen gas and carbon solid product mixture.

According to a fifth aspect, a system for producing hydrogen and carbon solid from liquid hydrocarbons is provided. The system includes a processing vessel having a first region for containing gas and a second region for containing liquid hydrocarbons. The system includes a cathode and an anode for forming or maintaining a DC plasma discharge between the cathode and the anode, wherein the anode is rotatable. The system includes a gas output in the first region. The system includes a carbon output in the second region. The system includes a liquid input in the second region for introducing liquid hydrocarbons to the processing vessel. The system includes a power source coupled to the anode and the cathode.

According to a sixth aspect, a system for producing hydrogen and carbon solid from liquid hydrocarbons. The system includes an array of processing vessels, each processing vessel having a first region for containing gas and a second region for containing liquid hydrocarbons. The system includes each processing vessel having a cathode and an anode for forming or maintaining a DC plasma discharge between the cathode and the anode, wherein the anode is rotatable. Each processing vessel has a gas output in the first region, a carbon output in the second region, a liquid input in the second region for introducing liquid hydrocarbons to the processing vessel, and a power source coupled to the anode and the cathode.

According to a seventh aspect, a method for producing hydrogen and carbon solid from liquid hydrocarbons is provided. The method includes introducing liquid hydrocarbons to a processing vessel. The method includes introducing a plasma-forming gas. The method includes forming or maintaining a plasma between a cathode and an anode based at least in part on the plasma-forming gas. The method includes directing a plasma jet formed from the plasma into the liquid hydrocarbons, so that hydrocarbons in the vicinity of the plasma jet are heated by the plasma jet to a temperature in the range between 1500 degrees K and 6000 degrees K thereby converting at least part of the hydrocarbons in the vicinity of the plasma jet into elemental constituents. The method includes cooling the constituents to form a gas and solid product mixture comprising hydrogen gas and carbon solid. The method includes extracting the gas and solid product mixture.

According to an eighth aspect, a system for producing hydrogen and carbon solid from liquid hydrocarbons is provided. The system includes a processing vessel having a first region for containing gas and a second region for containing liquid hydrocarbons. The system includes a plasma forming reactor having a cathode and an anode for forming or maintaining a plasma between the cathode and the anode and further having a nozzle for directing a plasma jet formed from the plasma into the second region. The system includes a gas output in the first region. The system includes a carbon output in the second region. The system includes a liquid input in the second region for introducing liquid hydrocarbons to the processing vessel. The system includes a power source coupled to the anode and the cathode.

According to a ninth aspect, a system for producing hydrogen and carbon solid from liquid hydrocarbons is provided. The system includes an array of processing vessels, each processing vessel having a first region for containing gas and a second region for containing liquid hydrocarbons. Each processing vessel has a plasma forming reactor having a cathode and an anode for forming or maintaining a plasma between the cathode and the anode and the plasma forming reactor further having a nozzle for directing a plasma jet formed from the plasma into the second region; a gas output in the first region; a carbon output in the second region; a liquid input in the second region for introducing liquid hydrocarbons to the processing vessel; and a power source coupled to the anode and the cathode.

### BRIEF DESCRIPTION OF THE DRAWINGS

The accompanying drawings, which are incorporated herein and form part of the specification, illustrate various embodiments.

FIG. 1 illustrates a hydrocarbon disassociation system, according to an embodiment.

FIG. 2 illustrates a hydrocarbon disassociation system, according to an embodiment.

FIG. 3 illustrates a reactor, according to an embodiment.

FIG. 4 illustrates a reactor, according to an embodiment.

FIGS. 5A and 5B illustrate a gas injection system according to an embodiment.

FIG. 6 illustrates a SEM micrograph of clusters of carbon particles at different temperatures according to an embodiment.

FIGS. 7A and 7B illustrate a dynamic cathode positioner according to an embodiment.

FIGS. 8A, 8B, and 8C illustrate a nozzle opening for the entry of feedstock gas into the system chamber according to an embodiment.

FIGS. 9A, 9B, and 9C illustrate a cathode according to an embodiment.

FIG. 9D illustrates a cathode insertion device according to an embodiment.

FIG. 10 illustrates a liquid hydrocarbon disassociation system utilizing a rotating drum creating liquid film according to an embodiment.

FIG. 11 illustrates a liquid hydrocarbon disassociation system utilizing an inserted cone-in-fluid intimate contact device according to an embodiment.

FIG. 12 illustrates a multitude of liquid hydrocarbon disassociation systems utilizing a rotating drum-creating-liquid film device as a method to combine fluid holding vessels, fluid filtering requirements, cooling requirements, and gaseous filtration and purification requirements according to an embodiment.

FIG. 13 illustrates a hydrogen disassociation system according to an embodiment.

FIG. 14 illustrates a processing vessel with top cathode according to an embodiment.

FIG. 15 illustrates the processing vessel with plasma torch or reactor on top according to an embodiment.

FIG. 16 illustrates a block process flow description of the hydrocarbon disassociation system, according to an embodiment.

### DETAILED DESCRIPTION

The following description is generally applicable to embodiments of a hydrocarbon disassociation system disclosed herein, including the hydrocarbon disassociation system shown in the figures of this disclosure. As described below, some embodiments are applicable to disassociating hydrocarbons in various forms, including gasses, liquids, semi-liquids, and the like.

In some embodiments, regardless of the plasma reactor type used, control software is employed to enhance the use of the plasma reactor, e.g., to improve energy usage, conversion efficiency, and so on, based on measurable parameters. In these embodiments, critical performance measurements may be monitored in order to enhance the control of the reactor. One measurement may include an amount of energy used to generate each kilogram of hydrogen, and in embodiments, a control system attempts to ensure that this value is consistent and as small as possible. In embodiments, for pyrolysis and thermolysis (high temperature pyrolysis without oxygen) processes, the following formulas may be utilized to support process controls to manage one or more of gas flowrates and pressures, power level between the cathode and anode, and magnet power for rotational speed, among other process parameters applicable to a given plasma reactor.

In embodiments, a process control measure may modulate one or more process parameters to sustain the mass and quality of product output. One process control measure may be kilograms (mass) per hour of hydrogen produced divided by kilograms of methane used. This percentage will be continuously compared to a threshold value, such as a laboratory documented ratio of 98%. When the percentage varies, directly controlled variables such as flow rates (e.g., controlled by one or more control valves) and electrical input (e.g., controlled by power supply controls) may be adjusted by an algorithm of the control software. The mass of methane used and its purity may be directly measured and compared to the following Formula 1 for consistency. The mass and purity of the hydrogen produced may be directly measured and calculated from the flow rates, temperature, and gas chromatograph measurement. The electrical variables of total energy, applied voltage consistency, and phasing voltage may be determined by the following formulas 2, 3, and 4. These are the result of controlled equipment variables, and since these have a direct impact on the methane conversion to hydrogen, their effect on the methane may be modulated to keep a consistent output volume and quality of hydrogen.

Formula 1: Mass Flows

Inₜₒₜₐₗ=Out_{solids}+Out_{Gas}+By-pass Gas/Hydrocarbonᵥₐₚₒᵣ

In=Current hydrocarbon mass flow rate as m³ per hr. direct measurement

Out_{solids}=Carbon black collected/exiting separation and cyclone mass

Out_{gas}=Calculated syngas mass flow minus monitored value CO₂ as a process control of O₂ contamination of input hydrocarbon/leakage of the system

By-pass gas/hydrocarbon=volume of flow from the filtering process that does not pass through the filter; or adsorbed by the sorbent; the unwanted part of purification.

Formula 2: Energy Used for DC/RF

Total Heating Energy=DC wattage+RF wattage (if used)−ORC generated wattage (ORC=Organic Rankin Cycle cooling apparatus)

Formula 3: Voltage Consistency

Delta voltage between cathode/anode=Direct measurement−Pre-Set parameter

Pre-Set parameter is experimentally determined and input as a reference variable; experimentally determination; done previously against product characteristics desired; H₂ percent conversion, carbon black desired product value.

The magnitude of the delta may be used by the controlling software program to adjust the cathode's position in embodiments using a position-able cathode that keeps the distance from cathode to anode consistent and the cathode position will be adjusted to keep this delta at a minimum;

The voltage at the cathode can be adjusted as a secondary method after the positioning software. A change in this voltage may/or may not be limited to a percent of range or statistical portion of the delta voltage as a first and minor adjustment, followed by the positioning change.

Formula 4: Anode Voltage/Phasing as a Method to Rotate the DC Discharge Around the Internal Diameter of the Anode to Create the High Intensity Plasma Volume that Enables the Dissociation.

Real-Anode voltage change (from the experimentally established median)=In gas flow rate change (a real-time measured parameter) (corrected for Gas Law of temperature to volume)*Pre-Set feedstock to product conversion percentage experimentally determined*Anode operating voltage (a real-time measured parameter) (V from 100 to 700 VDC rate of change per voltage unit=Real-time adjusted anode voltage change.

The goal of the process control software is to hold the primary conversion rate of hydrocarbon to hydrogen at the highest achievable value (e.g., 100%) or to another product quality characteristic at the lowest, consistent energy value. The measurement of process parameters, like pressures, flows, voltages, currents, for example, and enhanced by chemical analysis instruments downstream of the hydrogen and carbon separation process portion which will more directly determine the percent hydrogen content of the full gas stream, will be utilized by the above formulas within the software coding as compared to experimentally determined process parameter relationships, which are the formulas described above as formulas 1-4.

The construction and operation of the anode is done in such a way as to maximize the volume the discharge will travel around the reactor/torch plasma gas flow space. Both the voltage and the ‘spin rate’ of the discharge will impact operating results, like feedstock to product hydrogen to carbon black structure results. The control software will be utilized to keep the desired results constant.

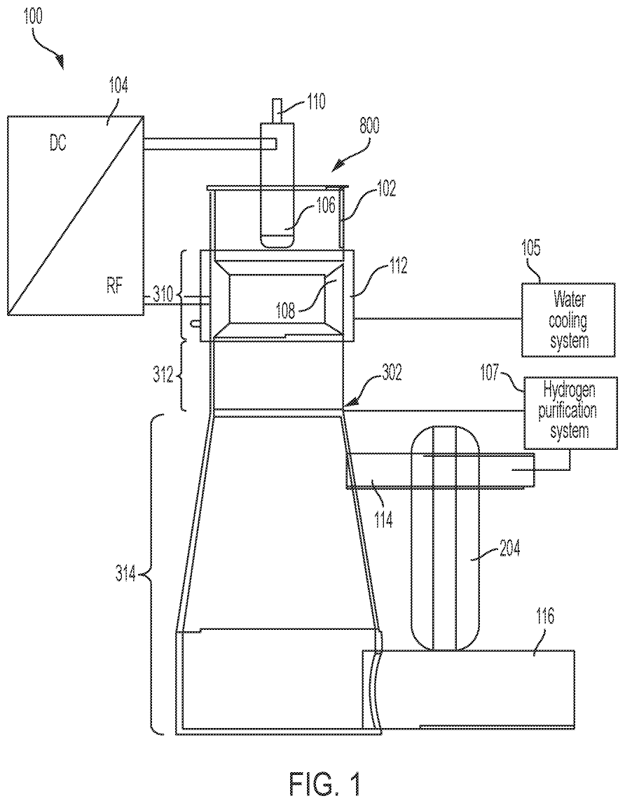

Some embodiments (such as those described herein with respect to FIGS. 1-9) are directed to reactors that are designed to disassociate hydrocarbon gas. These embodiments are generally described below.

In some embodiments, a plasma reactor is provided that includes a reaction chamber that may be formed by a water-cooled wall coated by ceramic. A DC discharge and/or arc plasma reactor may be part of the plasma reactor, and may include a DC plasma cathode. An electric arc, or arc discharge, is an electrical breakdown of a gas that produces a prolonged electrical discharge. Accordingly, for purposes of the present disclosure, the terms plasma discharge or plasma arc may be used interchangeably. The DC plasma cathode and a feed gas system may be located on the top of the reactor. A DC plasma cylindrical anode (electrically insulated from the cathode) is a part of the reactor and is located downstream from and co-axial with a nozzle. The anode is surrounded by a magnetic coil, or other apparatus for carrying electric current and providing a magnetic field. The magnetic field created by current passing through the coil causes the plasma to rotate, and the rotation speed of the plasma depends on the DC current (e.g., based upon drive voltage and total wattage, with typical values of 1,500 amps to 5,000 amps for a 1-megawatt system operating at 700 volts to 200 volts, respectively) and magnetic field (typically of 800 gauss (B) to 1,000 gauss (B)). A large anode area and high-speed rotation substantially increase the volume of the plasma, the process efficiency, and electrode lifetime.

RF power may also be applied in some embodiments, for example, between the cathode and anode and/or between the anode and feedstock injection plate. The frequency of the RF power may be tuned to an ion cyclotron resonance frequency (e.g., the ion cyclotron frequency for atomic hydrogen is 1.4 MHz for B=900 Gauss). By tuning the RF power to an ion cyclotron resonance frequency, the hydrogen ions may be accelerated and/or have their kinetic energy increased, such that the disassociation is improved. Exemplary operating parameters are listed below.

In some embodiments, the target temperature to disassociate hydrocarbon-containing gas is about1,500° C., and may be from about 1,000° C.-2,000° C. At this temperature, or within this range, the hydrocarbon may be disassociated at a high rate (e.g., more than 98% of hydrocarbon is disassociated), with efficient energy use, for example 5 kWh/kg H2 to 25 kWh/kg H2. The disassociation may still be successful at higher temperatures (e.g., greater than 2,000° C.), but the additional energy to reach those temperatures is effectively “wasted,” in that the disassociation is not substantially improved relative to the additional energy used.

In some embodiments, in order to reach the targeted temperature, the rotation speed of the plasma will be about 5,000 rotations per minute (RPM) to 6,000 RPM, and may be in the wider range from about 1,000 RPM to 6,000 RPM. The rotation of the plasma causes a more uniform temperature profile of the hydrocarbon containing gas (e.g., a plasma cloud) allowing the hydrocarbon containing gas to heat up to a desired temperature and disassociate. That is because the rotation of the plasma discharge causes the DC plasma discharge to affect a greater volume of gas, not just the gas that is close to a stationary discharge but all or substantially all of the volume of gas within the plasma processing zone.

In embodiments one or more sensors (e.g., optical spectroscopy, laser interferometry, stack gas chromatography, a flowmeter) may be used to monitor the process. For example, in the context of FIG. 1 (described below), one or more sensors may be used to measure the amount of hydrocarbon containing gas that leaves the reactor 102 through either of the hydrogen exit 114 and carbon exit 116 and/or that measures the amount of hydrocarbon containing gas that passes through the plasma processing zone or is in the quenching zone and/or separating zone. A sensor may also be used to measure the amount of hydrocarbon containing gas entering the reactor 102 through input 110. From these measurements, the amount of hydrocarbon containing gas that is disassociated may be determined. If the amount is too low (e.g., less than 98%), then a control circuit coupled to the anode power supply may alter the current flow so as to cause the plasma to rotate at a faster rate, or control other processing parameters such as gas flow rate, gas temperature, RF power, or other parameters to maximize decomposition efficiency.

FIG. 1 illustrates a hydrocarbon disassociation system 100, according to an embodiment. As shown, hydrocarbon disassociation system 100 includes a reactor 102, a plasma source 104, an input 110, a magnet 112, a hydrogen exit 114, and a carbon exit 116. Reactor 102 can be a cylindrical vessel, e.g., made of a dielectric material that contains the plasma and provides one or more regions or zones, such as plasma processing zone 310, quenching zone 312, and separation zone 314, for the disassociation of the hydrocarbon, the purification of the resulting hydrogen and carbon products, and provides outlets for collecting the resulting hydrogen and carbon products. In embodiments, the reactor 102 may be elongated, and a ratio of diameter to length may be from about 1:5 to 1:10 and may be arranged and operated in a vertical, horizontal, and/or angular configuration.

Plasma source 104 may include a direct current (DC) discharge plasma source, as shown in FIG. 1. The DC discharge plasma source 104 includes a cathode 106 and anode 108. Cathode 106 and anode 108 may take different shapes including cylindrical, conical, ring shaped, and other geometric configurations. Exemplary materials for cathode 106 and anode 108 include graphite, lithium cobalt oxide (LCO), lithium nickel manganese cobalt oxide (NMC), lithium nickel cobalt oxide doped with alumina (NCA), lithium manganese oxide (LMO), and lithium iron phosphate (LFP). Other materials are also within the scope of embodiments disclosed herein.

The DC discharge plasma source 104 also includes a power source, such as a DC power source. A plasma discharge is created when DC power is applied to cathode 106 and anode 108 in the presence of a hydrocarbon containing gas, and the plasma discharge occurs between the cathode 106 and anode 108. In some embodiments, the plasma source 104 may further include a radio frequency (RF) power source that can create an RF-based plasma between cathode 106 and anode 108. While the DC-based plasma is a single point and rotating discharge, the RF-based plasma expands to fill the volume of the reactor 102 within the plasma processing zone.

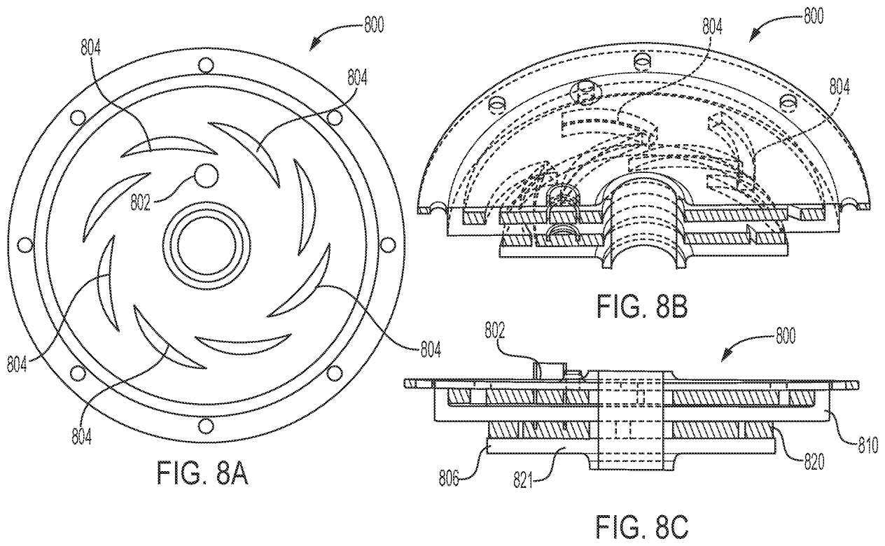

Reactor 102 includes input 110, which may be used to provide hydrocarbon feedstock gas into the reactor 102. The input 110 may have a nozzle that causes the hydrocarbon gas to rotate as it is fed into the reactor 102, such as gas exit 806 (shown in FIG. 8C). As shown, the input 110 (or gas inlet) is positioned within the cathode 106 at the top of the reactor 102. The nozzle may be angled or shaped in such a way to facilitate the rotation of the hydrocarbon gas as it is fed through input 110 and downstream of the nozzle further into reactor 102. An embodiment of input 110 is further described with respect to FIGS. 8A, 8B, and 8C. The magnet 112 may be a permanent magnet, or a coil or coils wrapped around reactor 102 that can induce a magnetic field when electric current is applied through the coil or coils, which could be thermally cooled. The magnet 112 is provided to help control and otherwise regulate speed of direction of the rotation of the plasma.

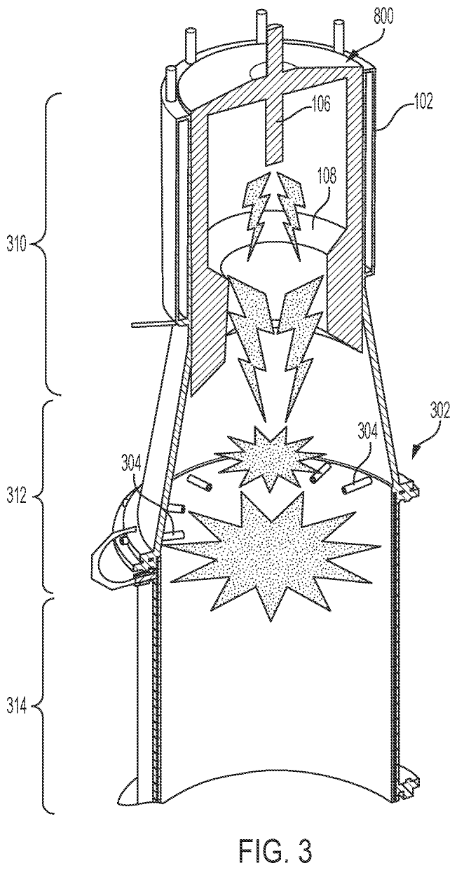

Hydrogen exit 114 is provided to allow the gaseous hydrogen to be collected. For example, hydrogen exit 114 may include a valve and piping allowing the hydrogen to exit the hydrocarbon disassociation system 100. The exiting hydrogen may include some amount of hydrocarbon gas and/or other impurities, and may be subject to further purification processes. In some embodiments, remaining hydrocarbon gas may be recycled back to the reactor 102, for example by being pumped into the gas injection system 302 (shown in FIG. 3).

Carbon exit 116 is provided to allow the solid carbon to be collected. For example, carbon exit 116 may include a rotating airlock and an auger or conveyor allowing the carbon to exit the hydrocarbon disassociation system 100 in such a way as to eliminate air intrusion. The auger or conveyor may be cooled (e.g., by fluid such as water).

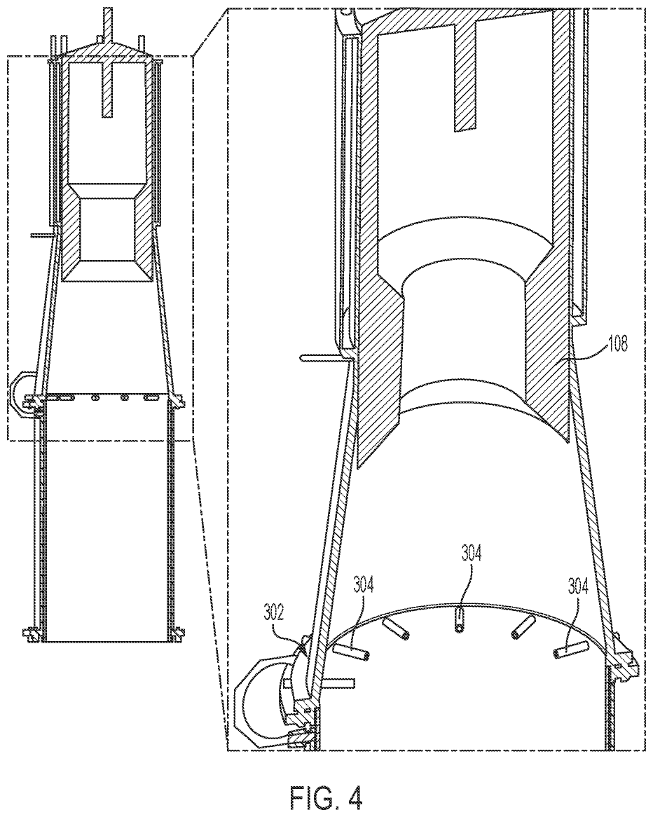

In some embodiments, a set of injectors (e.g., ceramic injectors such as nozzles or tubes 304, first shown in FIG. 3) may be provided in the quenching zone 312 (e.g., via gas injection system 302) to allow gas to be injected into the area and lower the carbon temperature from around 2,000K to about 1,000 K or about 500K. Hydrogen, having the highest thermal conductivity of all gases and being one of the gasses produced by embodiments disclosed herein, allows for carbon quenching without using water, which is advantageous over prior systems. This is described in more detail in connection with FIG. 3-4, 5A, and 5B.

Reactor 102 may be cooled, for example, by a water-cooling system 105 that is coupled to the reactor 102, e.g., in embodiments where it is permissible to emit carbon dioxide.

As shown, the reactor 102 is orientated vertically, and may be referred to as a vertical reactor. In embodiments, the positioning of the reactor 102 in this orientation can improve the efficiency of separation and purification of the hydrogen and carbon, e.g., by allowing gravity to assist in separating the solid carbon (which is heavier) from the gaseous hydrogen (which is lighter). Other orientations of reactor 102 are also possible (e.g., lateral (e.g., horizontal) or angular positions).

In operation, DC power is supplied to the cathode 106 and anode 108 to create a plasma. Hydrocarbon-containing gas is introduced into gas input 110 and enters into a processing zone in reactor 102 at an angle via an opening (such as gas exit 806 shown in FIG. 8C). In some embodiments, RF power may also be supplied to the cathode 106 and anode 108 to create a plasma, e.g., concurrent with the creation of the DC based plasma.

Ideally, the hydrocarbon containing gas is pure, or substantially pure, hydrocarbon; in practice, there will be impurities that need to be filtered out. Further, there may be a single hydrocarbon containing gas, or a mixture of different hydrocarbon containing gasses (e.g., methane and natural gas).

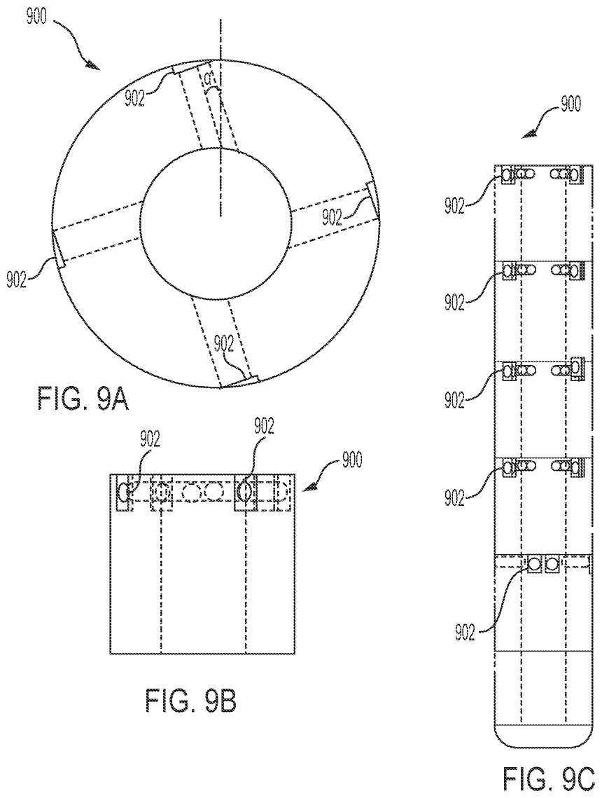

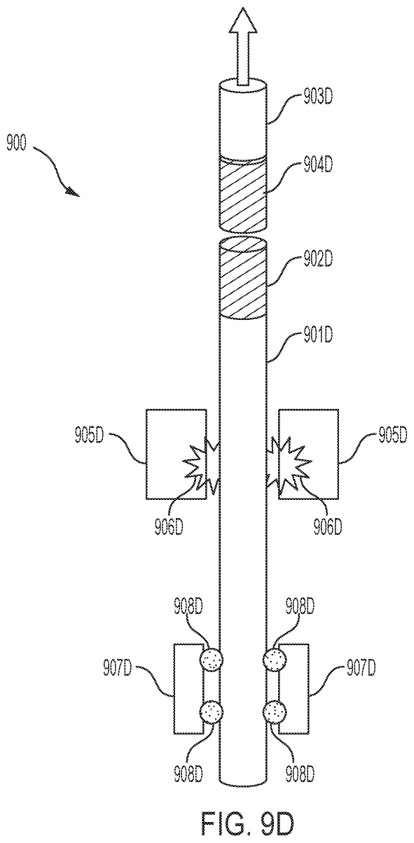

In embodiments, cathode 106 has ports (such as ports 902 shown in FIGS. 9A, 9B, and 9C) in the side imparting a physical spin rotation of the hydrocarbon-containing gas as it exits the nozzle of gas input 110 and enters into the plasma processing zone. As described below in connection with FIGS. 9A, 9B, and 9C, the ports 902 may have been angled by an angle a (as shown in FIG. 9A), e.g., where in some embodiments a may be in the range 10°-30°. This rotation of the gas imparted by the ports in cathode 106 is in addition to the rotation imparted by gas input 110 in some embodiments. When in the plasma processing zone, a small amount of the hydrocarbon containing gas (e.g., about 2%-3%) is changed to plasma (e.g., a high energy plasma), with the remainder of the gas being heated as it passes through the plasma processing zone. In this zone the spin of the gas imparts an angular momentum that carries all the gas into the DC plasma discharge, increasing mixing, and enhancing efficiency. As magnet 112 induces the DC plasma discharge to spin, the discharge is able to heat a larger volume of gas in the plasma processing zone. In embodiments, magnet 112 may cause the plasma to rotate at a rate of between 1,000 RPM and 6,000 RPM.

The gas flow of the hydrocarbon containing gas pushes the hydrocarbon containing gas into the plasma processing zone. Due to the discharge of high energy plasma and the rotation of the plasma, hydrocarbon containing gas passing through this zone is struck with the high energy and disassociates, at very high efficiency, breaking the carbon-hydrogen bonds in the hydrocarbon into singular hydrogen and carbon atoms, i.e., the elemental constituents of the hydrocarbon. In this zone, the hydrocarbon- containing gas is heated to a temperature in the range between 1,000° C. to 2,000° C., and in embodiments around 1,500° C., causing a majority or a substantial majority of the hydrocarbon to convert into its elemental constituents.

For example, in embodiments, over 90% of the hydrocarbon containing gas is disassociated, in other embodiments, over 95% dissociation is achieved, in other embodiments over 98% is achieved, and in other embodiments substantially 100% (e.g., 99.99%) is achieved. Process control parameters, for example, but not limited to, gas flow rate, can modulate this resulting dissociation efficiency. There will be a nominal flow rate that will achieve 99.99% disassociation, and will be monitored by the spectral analysis of the output gas for organic feedstock gas (e.g., methane) being below a threshold amount (e.g., below a detection limit of the equipment). As process gas flow rate is increased above this point (i.e., the nominal flow rate), the energy from the plasma will not be enough to achieve the approximate 1500° C. dissociation temperature and some un-dissociated hydrocarbon (e.g., methane) will pass through unchanged, and will be detected by the sensor previously mentioned. An increase of 0% to 3% of the nominal flowrate will cause a 98% conversion result. An increase of 3% to 5% will cause a 95% result, and so on (as based upon process simulations and experience of inventors).

These singular elements pass out of the plasma processing zone into the quenching zone (312), for example, based on a pressure differential caused by the gas being heated in the plasma processing zone. After the quenching zone, the singular elements pass to the separation zone. Here, in the separation zone (314), hydrogen will recombine as it cools down into its natural state of H₂, and passes out of this zone as a gas. Because the gas is rotating as it enters into reactor 102, and the gas and later the constituent elements will tend to continue rotating downstream, in the separation zone 314 the disassociated carbon tends to move towards the walls of the reactor 102 (within the separation zone 314) based on the centrifugal effect. The quenching process, which controls the carbon product, is further described with respect to gas injection system 302, and length of quenching zone 312 as the important ‘time of contact’ or quenching rate. The carbon will recombine into its natural state as a solid particle, aggregate, or agglomerate mass, which is heavier than the hydrogen. These particles will drop to the bottom of the separation zone under the force of gravity and can be removed to the carbon exit, e.g., by an auger, conveyor, or other mechanical apparatus.

As the carbon falls in reactor 102, some carbon particles (or aggregate or agglomerate mass) will line the walls of the reactor 102. At this point, the solid carbon is very dry, and the thickness of the carbon on the walls of the reactor 102 will be small, with the remaining carbon dropping to the bottom of the separation zone. In embodiments, the walls of reactor 102 may be coated in a manner to prevent carbon buildup. In embodiments, the geometry of the walls and/or the surface material of the walls and/or coating applied to the walls of reactor 102 may also influence the amount of carbon buildup. In other embodiments, the limited carbon buildup that occurs can help improve thermal insulation of the reactor 102.

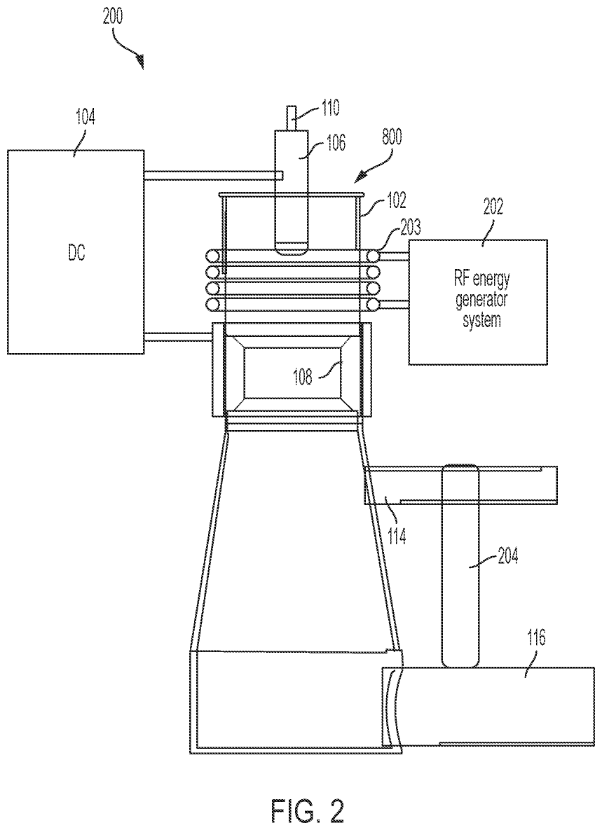

FIG. 2 illustrates a hydrocarbon disassociation system 200, according to an embodiment. Some of the components of system 200 are similar to those described with respect to system 100, and for those components the same reference numerals have been used to indicate similar components. System 200 differs from system 100 in that a hybrid plasma reactor is provided by way of DC discharge plasma source 104 and a separate RF plasma source 202. System 100 in some embodiments may include an RF-based plasma between the cathode 106 and anode 108. In system 200, the RF-based plasma is generated by the coil 203 around the reactor 102, which is a separate plasma source than that used in system 100. RF-based plasma is advantageous in some embodiments, for example, because it can be easier to stabilize than DC-based plasma, can provide for more uniform temperature across the reactor 102, will impart additional energy increasing molecular collisions from the angular momentum already imparted by the gas injection spin, as previously noted, and can create a higher volume of plasma in the reactor 102. RF-based plasma by itself can, in some cases, have difficulties with efficiently processing hydrocarbons, and therefore in embodiments the RF-based plasma is combined with the DC-based plasma to improve the system efficiency.

RF plasma source 202 uses RF energy to create plasma, e.g., an inductively coupled plasma (ICP). RF plasma source 202 may include coils 203 which provide the electromagnetic induction needed to generate the RF-based plasma (e.g., ICP). RF plasma source 202 introduces an RF based plasma into the plasma processing zone in reactor 102. In the plasma processing zone, the physically rotating hydrocarbon containing gas is energized by the RF power, which may be controlled to have certain parameters (e.g., frequency, amplitude, bias) such that the created plasma has a high amount of energy, so that the hydrocarbon containing gas is heated and expands to fill the entire plasma processing zone.

In embodiments, a typical frequency of the RF power source may be between 1.76 MHz and 13.56 MHz, and amplitude may be from about 5 kV to about 10 kV. By expanding the hydrocarbon containing gas to fill the entire plasma processing zone, the volume of processing is maximized, making the resulting disassociation more efficient. In embodiments using both DC and RF based plasmas, this double energizing (i.e., by both the DC and RF based plasmas) of the hydrocarbon containing gas leads to even higher conversion efficiency, potentially at lower DC power. Once dissociation of the hydrocarbon containing gas has occurred, as noted above, the constituent elements pass into the separation zone. A filter 204 may be coupled to the hydrogen exit 114 and carbon exit 116. For example, as hydrogen passes through hydrogen exit 114 it may interact with filter 204 so that any carbon particles passing through may be caught by filter 204 and optionally allowed to enter into carbon exit 116. Additionally, as carbon passes through carbon exit 116, an opening in the carbon exit 116 may allow any gas within carbon exit 116 to interact with filter 204 so that any gas passing through carbon exit 116 may be allowed to enter into hydrogen exit 114. Because the gas is still hot as it passes through carbon exit 114, it will tend to rise and pass through the opening so that it can further pass through filter 204 and into hydrogen exit 114. Filter 204 may include a ceramic high-temperature filter.

FIGS. 3 and 4 further illustrate hydrocarbon disassociation systems. Reactor 102 is similar to the reactor 102 shown in FIGS. 1 and 2, and in general, the same reference numerals have been used to indicate the same or similar components. Reactor 102 includes gas injection system 302. Gas injection system 302 may include a plurality of nozzles or tubes 304 for allowing gas to enter into reactor 102 in the quenching zone 312. The nozzles or tubes 304 may be radially spaced. In embodiments, hydrogen that has passed through hydrogen exit 114 is re-introduced into reactor 102 through the tubes 304 for cooling, causing quenching and helping to process the carbon product into carbon black. In general, the processing performed by reactor 102 can be divided into zones 310, 312, and 314. Plasma processing occurs in zone 310, aggregation and quenching occurs in zone 312, and separation occurs in zone 314, where the products may also be further processed, filtered, and/or removed from reactor 102.

Advantages of systems disclosed herein is that they generally require less energy to decompose hydrocarbons, almost all energy put into plasma goes into disassociation process, and therefore the system is much more efficient. In some embodiments, systems may achieve an efficiency of about 24 kWh/Kg, and in some embodiments, the efficiency may be from about 15 kWh/Kg to about 30 kWh/Kg. Prior art systems are significantly less efficient.

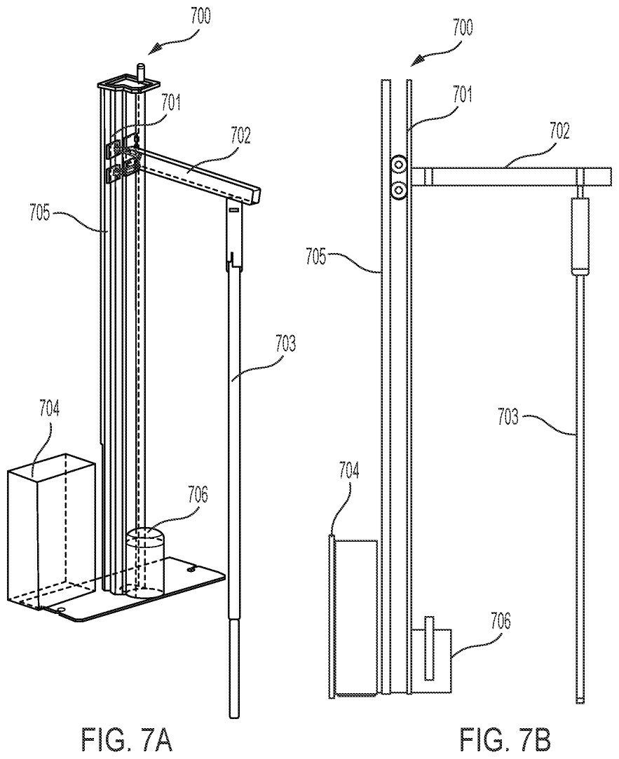

The following applies generally to any hydrocarbon disassociation system disclosed herein, including hydrocarbon disassociation systems 100 and 200. Cathode 106 may optionally be capable of moving. Through use, the material of cathode 106 deteriorates and is etched away, thereby growing smaller over time. By controlling the location of cathode 106, for example, to maintain a fixed distance between cathode 106 and anode 108. This can improve the operation of the system over time, and increase the time of continuous operation before cathode 106 must be replaced. A dynamic cathode positioner is further described with respect to FIGS. 7A and 7B. Positioning will be controlled by electrically driven correction, with magnitude of positioning change continually determined by a monitoring of the cathode to anode feedback and operating currents.

Exemplary hydrocarbon-containing gases used in embodiments disclosed herein include methane, natural gas, compressed natural gas (CNG), petroleum gas, syn-gas, bio-diesel, and other types of hydrocarbon including combinations of any of these.

In embodiments, the hydrogen and carbon from the hydrocarbon-containing gas are separated by centrifugal effect of the rotating plasma. In particular, the rotation of the plasma creates a more uniform heating of the space in the reactor 102, causing a higher volume of the hydrocarbon containing gas to be disassociated than would otherwise be the case due to angular momentum collisions rates. The different (e.g., opposite) rotation by the hydrocarbon containing gas, on the one hand, and the plasma, on the other hand, enhances the angular contact between the plasma and at least a portion of the hydrocarbon-containing gas, resulting in greater disassociation effects and efficiencies. Each of the hydrocarbon-containing gas and the plasma may rotate in one or more of three dimensions, e.g. an x-, y-, and z-dimension, and the rotation of each may be different in one or more of these dimensions. The differing rotation of the hydrocarbon containing gas and plasma, as well as their respective angular momentum, improves the heating of the hydrocarbon-containing gas by making it more uniform. The centrifugal effect moves the heavier carbon particulates toward the cooled wall, where part of the quenching process occurs. Hydrogen is transported to a heat exchanger (not shown) and cyclone dust separator (not shown) for cooling and heat recuperation. Carbon powder is collected on the walls and bottom of the water-cooled reactor, creating a plug of material at the exit port isolating air from the reactor chamber, and transported to packaging system by water cooled conveyor/auger. A hydrogen purification unit (e.g., hydrogen purification system 107) based on high selectivity membranes or pressure swing absorbent for extracting high purity hydrogen from the gas stream generated in the plasma reactor may be located nearby so that the gas that has exited the hydrogen exit 114 may be passed through the hydrogen purification unit.

Different properties of carbon black make it useful depending on the application of the carbon black in different industries. For example, physical properties like particle size, and/or surface activity (as tested by nitrogen entrapment) and/or iodine adsorption, among others, can affect the value of the carbon black for industries such as tire manufacturing, rubber for belts and hoses, plastics, food service, carbon fiber, and other black materials. These properties can be controlled during the processing of the hydrocarbon disassociation system, for example, by manipulating the processing parameters of electrical power, gas speed, gas mix, time of flight/cooling, and so on. Adjusting the particle size and other properties are important to supplying desired grades of the product, e.g., to the industries of tire manufacturing, plastic compounding, additives to paints and ink, and many other industries. Accomplishing this in process with the generation of hydrogen, at no additional energy cost, creates beneficial economics offering a second product to the marketplace that already has a growing global need.

A method to alter the time of cooling (i.e., quenching rate) is proposed in embodiments. The method includes providing an adjustable cool gas curtain by using the generated hydrogen gas, such as by using the gas injection system 302 shown in FIG. 3. Moments after the disassociated constituent elements pass the plasma reactor anode where the decomposition occurs, they begin to cool. The constituent elements form a hot jet stream, including elemental carbon that, through turbulent collision dynamics, aggregate into small clusters that resemble grapes on a stem. Cooling may also be controlled by adjusting the distance between the anode and quenching gas ring, known as the time of flight. That is, a longer distance (or longer time of flight) results in more cooling, a shorter distance (or shorter time of flight) results in less cooling.

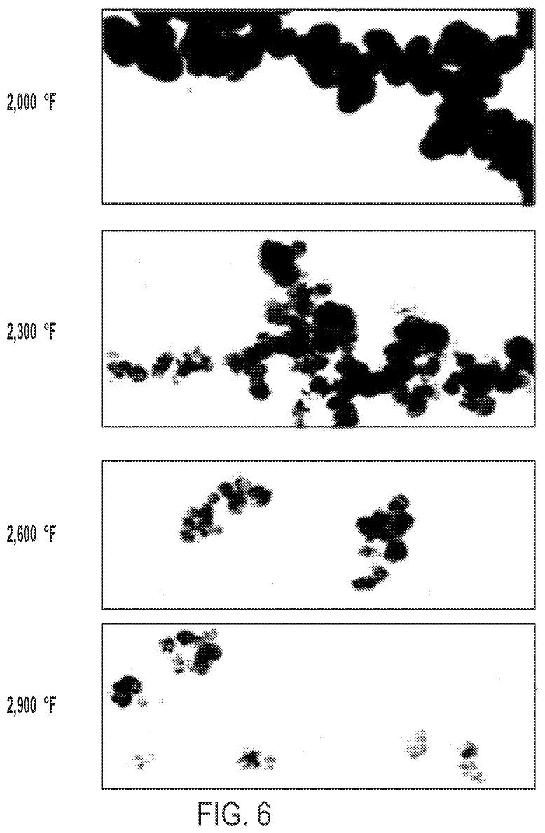

FIG. 6 is a SEM micrograph of clusters of carbon particles at different temperatures. The hot jet stream carries these extremely fine carbon particles, and the longer the carbon particles remain hot (e.g., more than 1,000° C., and typically in the range from 1,000° C. to 2,000° C.), the larger and more complex they get, as shown in FIG. 6, since the finest particles start at 2,000° F. (or about 1,100° C.) and cool by convection and collision until they are cool enough for the process to stop. Artificially stopping this process, called quenching, is done by injecting the generated hydrogen gas, which has been cleaned and cooled, into the appropriate portion of the tail of the hot jet stream. Injecting the generated hydrogen gas dramatically reduces the temperature of the hot jet stream, and therefore can control the properties of the carbon, e.g., the size of clusters that the carbon particles form into. It is known, for example, that the time range needed for quenching is from about 30 milliseconds to about 90 milliseconds. A quenching position may be calculated, for example, based on the gas speed exiting the anode position and placing the gas injection at about 40 milliseconds to about 60 milliseconds downstream from the anode 108, depending on the properties desired.

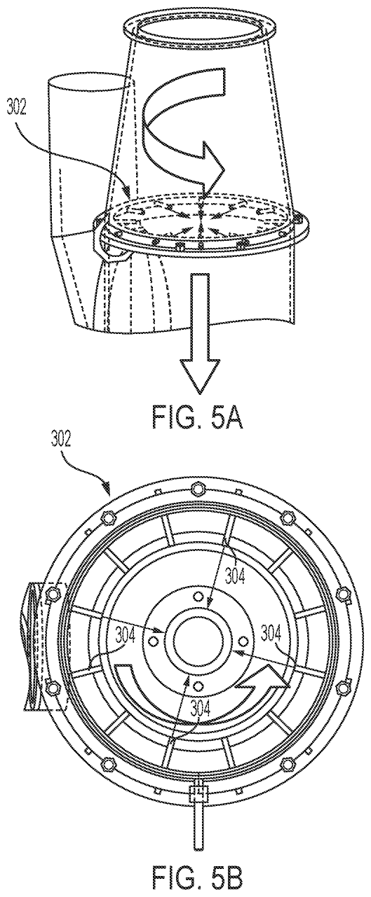

In embodiments, post-dissociation gas temperature quenching may be used to halt carbon re-association into a particle, aggregate, or agglomerate. The size of the resulting carbon product may be determined by the process parameters of the dissociating plasma and the position within the reactor 102 where rapid cooling takes place. A specific median and range of carbon particle sizes may be experimentally predetermined and is adjustable within the quenching zone by, for example, moving the location of the rapid cooling. In embodiments, quenching may be accomplished, not by water to steam as is conventional, but by pre-cooled inert gas or, preferably pre-cooled hydrogen product gas. This is accomplished in some embodiments by a pre-determined nozzle apparatus, such as gas injection system 302. The nozzles or tubes 304 may be made of high temperature ceramic and may be aimed into the center of the flow, placed as a ring around the circumference of the internal dimension of the joining chamber immediately after the plasma jet connection, but also adjustable as to axial positioning downstream from the plasma processing zone up to 50% of the length of the separation zone. Said device will be made of a material, like stainless steel with ceramic nozzles, but not limited, and may be fluid cooled so as to withstand the operating temperatures of the post-plasma chamber environment. As shown in FIGS. 5A and 5B, the particle containing hot jet stream moves downstream from the anode position and the gas continues rotating, due to the specific injection through input 110 which creates an angular (spinning) gas velocity and increases the turbulent contact with the high energy plasma. The spinning gas passes the cool injected hydrogen injection nozzles 304, and in some embodiments may achieve a quenching rate of approximately 10⁶ K degrees/sec, reducing the temperature significantly below 1,000° C., so that the aggregate formation stops, and the carbon black formation has been adjusted to a small size and high value grade, such as N300 and lower. N300 refers to a grade of carbon black, having a particle size of 30 mm±mm. The quenching rate for this process, K/sec, is related to the rate of change of temperature in degrees Kelvin per second and is determined by molecular collision dynamics.

The process disclosed herein may run on a continuous basis with little or no interruption, which minimizes downtime impact from maintenance. Allowing the process to stabilize and operate at favorable nominal process parameters leads to more consistent product quality. One of the few maintenance interrupts for the disclosed process is the replacement of high temperature cathode 106 in reactor 102. Due to the etching effects from the high current on cathode 106, which may be made of graphite or graphite composites, for example, and made at desirable dimensions specifically to extend its useful lifetime, cathode 106 will erode over time and must be replaced. In some embodiments, the cathode is positioned relative to the anode to regulate the size and potency of the plasma energy, and in embodiments this dimensional feature is within approximately +/−10% of a predetermined value. Because of this erosion that occurs over time, this dimension changes with continued use. In some embodiments, a significantly longer cathode part than otherwise would be used, e.g., two to ten times the nominal design length, may be used in order to extend operating life. Further, in some embodiments, there may be a mechanism which slowly insets the extra length of cathode 106 at a predetermined erosion matching rate (e.g., on the order of millimeters per day), such that the required cathode-to-anode position is held relatively constant, e.g., within +/−10%. This mechanism is an active process control device, which is also known as a dynamic cathode positioner. Further, in some embodiments, the cathode rod can be attached (e.g., screwed) onto the existing rod, extending the life without system stoppage.

FIGS. 7A and 7B illustrate a dynamic cathode positioner 700 according to an embodiment. The cathode 703, which may be a rod shape and secured in a holder 702 that is secure enough to support the cathode (e.g., made of graphite) without breakage, but is also designed to interface with an injection screw 701 device injecting the cathode into the reactor 102 and plasma processing zone 310. A speed adjustable insertion device 705, coupled to the holder 702, is capable of guiding the cathode, e.g., by a motor, establishing the insertion rate (e.g., on the order of millimeters per day), and sealing the cathode from allowing air leaks into the plasma processing zone 310. Power supply 704 is also provided, which may include timing and control circuitry, with an operational software interfacing screen. Insertion device 705 may include a long support channel with a bearing loaded screw 701. This screw has a fine thread running the length of it, and a fine positioning stepper motor 706 is at the base end to rotate the screw therefore creating linear motion of the holder 702 up and down. On this threaded screw and mounted in the channel, in such a way as to move freely from one end of the channel to the other, is a lubricated mount that has a clamping device coupled to the holder 702 to hold the cathode 703 at one end. At the other end, the base, is the mount to bolt this device to the top of the reactor 102, the rod guide, and seals to keep air out of the reactor 102 and the screw motor 706.

The software for the dynamic cathode positioner may operate the cathode insertion past the air seal into the plasma processing zone 310 to the anode-narrowed diameter of the reactor 102. For example, the software may be based on process modeling and/or experimental proof, and in some embodiments may operate at a predetermined rate or may be adjusted to take into account operating conditions. For example, specific power supply operating parameter ranges, like voltage consistency, may be used as a backup to the pre-determined insertion speed rate. The plasma main power may be held at a constant current and the voltage may be varied to hold the high temperature disassociation process constant. If the voltage operating range begins to vary too much, then this could be a signal that the cathode is out of nominal position. A software algorithm may be used to change the insertion rate to adjust for this process change.

FIGS. 8A, 8B, and 8C illustrate, respectively, a top view, a cut-away perspective view, and a side view of a gas input head 800 according to an embodiment. Gas input head 800 may be used, for example, as the gas input 110 shown in FIGS. 1 and 2, and may be located at the top or substantially at the top of the reactor 102. As shown, gas input head 800 has chambers 810 and 820, and may have cooling water running in the top-level chamber 810 and gas dispersion in the lower-level chamber 820. The lower-level chamber 820 has directional vanes 804 that serve to control the flow of gas in the otherwise hollow chamber. The vanes 804 may be machined, for example, and not limited to, into the hollow cavity of chamber 820. In embodiments, the vanes 804 take up less than 50% of the available volume, and in some embodiments less than 25%.

The vanes are shaped and placed in such a way as to cause the gas within lower-level chamber 810 to rotate as the gas travels to the exit 806. The exit 806 is a gap between the chamber 820 and a plate 821 where gas is able to escape from. The edge of this vaned chamber 820 has a diameter less than the diameter of the reactor 102, and therefore gas being pushed from this chamber 820 moves easily into the plasma processing zone of reactor 102 as it passes through exit 806. Gas is injected into the input hole 802 (off center) in the top of the gas input head 800. The gas fills the central area where the tilted vanes 804 are. It is then squeezed out between the vanes imparting tangential direction. This direction creates a spin on the gas as it leaves the gas input head 800 and enters the plasma processing zone of reactor 102.

FIGS. 9A, 9B, and 9C illustrate, respectively, a top view, a partial side view, and a side view of a cathode 900 according to an embodiment. Cathode 900 may, for example, be configured in place of cathode 106 shown in FIGS. 1 and 2. Ports 902 may be located in the side of cathode 900 imparting a physical spin rotation of the hydrocarbon containing gas as it exits the nozzle of gas input 110 and enters into the plasma processing zone. Ports 902 are angled such that, in some embodiments, the angular off-set a shown in FIG. 9A, may range from 10°-30°. This angle represents an angle from a longitudinal axis of port 902 with respect to a line from the outer edge of cathode 900 to the cathode center. The different ports 902 may have the same angle in some embodiments, and in other embodiments may have different angles within the range from 10°-30°. The angular off-set a causes ports 902 to impart a physical spin rotation of the hydrocarbon containing gas as it exits the nozzle of gas input 110 and enters into the plasma processing zone.

FIG. 9D shows a cathode insertion device 900D according to an embodiment. A cathode 901D to be inserted has, as shown, a machined screw feature (or other end to end mateable connecting method), on each end shown as 902D, such that this screw feature allows for elongating the cathode by screwing a male feature of a new cathode length into a female feature of the current cathode in use, therefore allowing for continuous operation. This cathode 901D is in a motorized and metered device 905D capable of moving cathode 901D. The motor of this device may be a digital servo motor, such as one known to the industry, with accurate movement controlled by an electronic circuit of a digital control board and computer. As shown in one embodiment, cathode 901D is pinched between cog wheels 906D that are part of the motorized and metered device 905D, and in particular, is pinched between cog wheels 906D at a sufficient resistance as to push the cathode 901D down into the reactor 102 (not shown in FIG. 9D). Cog wheels are mechanisms that transfer controlled motor rotation, for example by (but not limited to) digital servo-type motors as part of 905D with gears to the motor on one side and a friction device gripping the cathode on the other. This gripping method maybe by rubber-like material, or by grooves in a metal wheel of sufficient depth and material strength as to move the cathode but not damage it. Cathode insertion device 900D may be used to insert appropriately sized cathode used in the disclosed embodiments, such as cathode 106 shown in FIG. 1. In embodiments, cathode insertion device 900D may include a water cooled specifically designed seal 907D with specific material seals 908D that allows the cathode to move into the reactor 102 and not allow air into reactor 102. The seal, in one embodiment, can be a two part double seal that encircles the entire diameter of the cathode and is a heat tolerant material of, but not limited to, rubber, synthetic nylon, Teflon, etc., where this material is at each end of an integrated tube in such a way as to create an airlock along a certain length (e.g., one to six inch length) of the cathode keeping air out of the reactor. Also, this seal 907D and drive 905D are electrically isolated from the charge placed on cathode 901D via a connection within 907D. In addition, since the plasma generation processes described herein may erode the cathode 901D over time, there is a need to be able to replace cathode 901D within reactor 102. As shown, an additional cathode 903D with a matching screw thread 904D to that of 902D can be attached to the threaded end 902D of cathode 901D. That is, the screw thread ends 904D and 902D mate together. This allows for continuous and uniform system operation.

A reactor system could include a single reactor or a plurality of parallel reactors, of the same or different types. In other words, the hydrocarbon disassociation systems disclosed herein are modular.

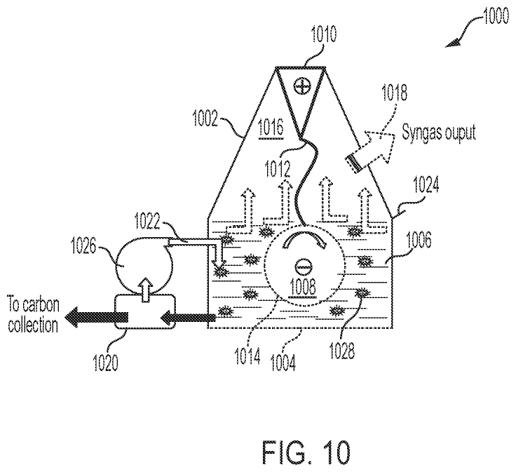

Some embodiments (such as those described herein with respect to FIGS. 10-16) are directed to reactors that are designed to disassociate hydrocarbon liquids, semi-liquids, oils, and the like. These embodiments are generally described below.

Embodiments also describe the method and control systems for maintaining the proper and adjustable liquid surface level of the feedstock liquid housed, temperature controlled, and maintained in the vessel. The removal of carbon rich fluid from this vessel during continuous operation will require a return of the filtered fluid to the vessel for continued processing, monitoring the opacity of the fluid for control of the filtering quality, and for replenishing the proper fluid level with new feedstock, as a consistent volume will be converted and the original volume of the fluid depleted.

Embodiments herein describe processes and apparatus for generating hydrogen and carbon (e.g., carbon black) by disassociating methane and other gaseous hydrocarbons through the utilization of the plasma generating system that utilizes, among other things, a DC plasma discharge reactor and/or DC Plasma discharge with RF ICP Plasma reaction chamber on all (or part) of the gaseous hydrocarbon gas, and by the transfer of heat from the plasma stream exiting the plasma torch/zone into the remainder of the gaseous hydrocarbon gas, and imparting that high energy into the liquid contained in the vessel creating gaseous hydrogen and solid carbon. These two products are immediately separated since the carbon remains in the liquid; and the gas, being hot, rises to the gas vent. In embodiments, a hydrocarbon gas is introduced into the reactor or torch chamber in an angular manner such that the hydrocarbon gas rotates within the chamber and comes into rotational contact with a plasma that has been created within the chamber. In some embodiments, the DC plasma also rotates within the chamber at high rotational speed and in a different (e.g., opposite) direction compared to the rotation of the hydrocarbon gas, as regulated by plasma-controlled magnets, the voltage and sequencing control software, and an integrated portion of the anode part of the cathode/anode pair making up the plasma reactor.

In some embodiments, the plasma and hydrocarbon gas are caused to rotate in opposing directions. The relative angular rotation of the gas and plasma results in the increased occurrence of the plasma coming into contact with the gas and dissociating the hydrocarbon into its elemental components of hydrogen and carbon, and processes are provided for separating and refining the resulting products, such as quenching into the vessel liquid to produce carbon black. As the dissociated gas has an angular momentum due to the imparted spinning at the injection cap of the plasma zone and imparted by the opposing magnetically controlled DC discharge rotation, the carbon containing gas is spun outward from centripetal force to the liquid, which are also cooled by chilled water in the vessel walls, and this stops/quenches the combining process of carbon with carbon at the nano and micro-size scale, therefore establishing the aggregate structure of the carbon black (the result of elemental carbon combining with elemental carbon). This then forms the properties of the carbon black, collected in the fluid, filtered from the fluid, reduced of fluid to a dry quality, and later sorted by different processing methods and equipment.

Different plasma technologies may also be used, including, for example, a DC plasma, or a combination of DC and RF plasma along with controllable processing parameters, for example but not limited to, plasma gas flow rate and velocity (as imparted by the controllable pressure of this raw gas), post-plasma zone raw gas flow rate, cathode and anode voltages, the rotation speed of the DC discharge plasma, and others. The controllable processing parameters may be used, for example to expand the plasma heating volume which the feedstock gas will be flowing through and being decomposed.

In some embodiments, the liquid conversion method may encompass the filtration of the liquid, the drying of the filtered carbon black, the plasma torch or reactor and heat generating method, the attachment of this heat generating method to the liquid vessel, the method and equipment of the hydrogen product gas venting, cooling, collection, filtering, de-vapor/fluidizing, purification of the product hydrogen, the control systems for the plasma energy and the fluid replacement control and processing all filtered, de-oiled, and semi-dried carbon solids by a pyrolytic kiln.

In some embodiments, pre-treatment of the feedstock fluid prior to loading to the vessel may be applied, and the post-generation treatment of the gaseous hydrogen product, and the post-treatment of the generated solids (e.g., carbon black) may be applied. The pre-treatment of the feedstock fluid may include mixing bulk deliveries to create a more uniform fluid composition placed in the vessel, chemical analysis to allow for adjustment of processing parameters as an effort to maximize product quality and characteristics driven by the business, solids removal and/or filtering, de-gassing, and de-watering.

Embodiments include the post-treatment methods for the gaseous hydrogen product that has exited the processing vessel through the upper sealed vent, passing into a process vapor mist condensation device, into a compressor for hydrogen up to, but not limited by, 30 bar in pressure, then across a membrane hydrogen purification device resulting in an approximate 99.9% hydrogen purity. By-pass gas from this purification step will generally be high in hydrocarbon content, so will therefore be cycled back to the plasma generator.

In some embodiments, the high temperature plasma gas steam emits from the chamber at high temperature (2,000° C. to 6,000° C.) and this plasma is created perpendicularly into a vessel containing a second hydrocarbon feedstock. This high temperature plasma gas steam is intimately contacting the liquid feedstock, imparting heat energy, and causing the feedstock to decompose into hydrogen and carbon. A consistent carbon black composition and surface qualities may be obtained, for example, by quenching the carbon aggregate formation in a controlled manner, e.g., in less than one second. The method includes the generation of hydrogen from this interaction as a bubbling of newly created molecular hydrogen (H₂) which separates from the liquid, since it is a gas. The method includes separating the carbon (solid) from the hydrogen (gas) as the carbon remains and collects in the liquid, providing a solid-in-liquid part and a gas part. The gas part rises above the liquid and is collected into a vent pipeline where it is cooled and further filtered of droplets, fumes, particulates, etc., and is cooled for purification. The carbon-containing liquid may be filtered of the carbon, which is further processed into a dry solid, and the excess liquid is returned for processing in the vessel.

In some embodiments, the method includes quenching the carbon (solid), wherein the carbon (solid) comprises carbon black, and the carbon black formation is stopped by the temperature of the liquid around the portion that is struck by the DC discharge. In some embodiments, the hydrocarbon gas used for plasma stream generation is contained in a gas that is substantially devoid of oxygen, nitrogen, and sulfurs. In some embodiments, the amount of oxygen, nitrogen, and sulfurs in the gas is less than one molar percent. In some embodiments, the liquid feedstock has been prepared to reduce the presence of water. In some embodiments, separating the carbon (solid) from the liquid feedstock hydrocarbon comprises removal, by fluid pumping, a portion of the liquid to a solid-liquid separation device which may include, but is not limited to, a filter press, a centrifugal device, and caking device, an auger press, or other device that is designed to remove all or a portion of the carbon. In an embodiment, the carbon ‘cake’ is removed via a fluid cooled auger in such a way as to restrict the reintroduction of air into the carbon cake (solid).

In some embodiments, the carbon cake is further processed in a no oxygen pyrolysis rotary device where the moist/liquid oils remaining with the carbon are volatized into a syn-gas of high caloric value. In this embodiment this syn-gas could be burnt as the source of heat for this rotary device. In another embodiment, this syn-gas is returned to the plasma generating chamber where it is utilized for generating the heated plasma steam. In this embodiment the now dried and de-oiled carbon is collected, cooled, and classified into a carbon black salable product.

In some embodiments, the liquid feedstock hydrocarbon is heated to a temperature between 1,400° C.-2,000° C. by the gaseous hydrocarbon plasma stream.

FIG. 10 shows a hydrocarbon disassociation system 1000 according to an embodiment. As shown in FIG. 10, the system 1000 has a liquid reactor 1002 including a vessel 1004, where in some embodiments, the entire vessel 1004 encompasses all or most of the components of the reactor 1002. Liquid hydrocarbon feedstock 1006 to be processed is held in the vessel 1004, e.g., at constant level at or near the top (apex) of the anode rotating element 1008. In an embodiment, a cathode 1010 is located over an anode 1008 at an appropriate distance so as to facilitate the creation of a DC discharge plasma 1012 from cathode 1010 to anode 1008. In embodiments, rotating anode 1008 may be in the form of a drum, and the rotating anode 1008 may pull a thickness of liquid 1006 up onto its surface and into the path of the discharge plasma 1012. The thickness of liquid 1006 on the surface of rotating anode 1008 may form a fluid layer 1014, which will depend on the viscosity and surface tension characteristics of the liquid as it relates to the surface of the rotating anode 1008. In embodiments, the fluid layer 1014 may be from about 0.1 mm to about 6 mm in thickness.

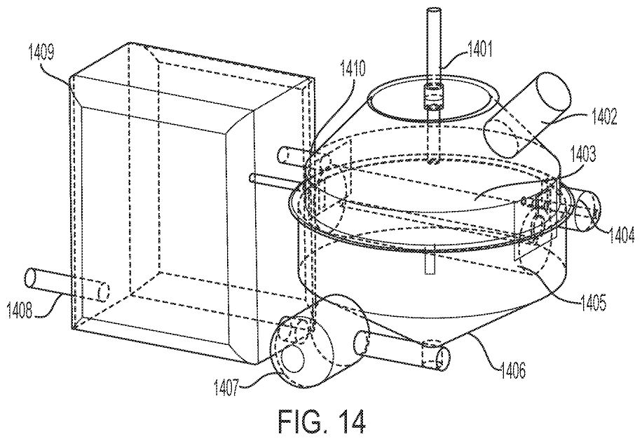

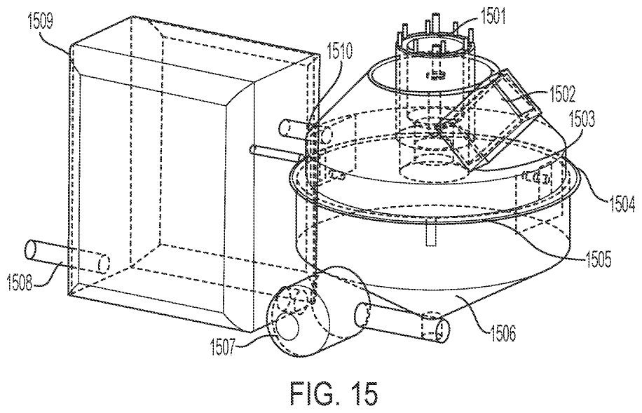

Decomposition of the fluid 1006 occurs during this process; hydrogen gas is emitted into the space 1016 above the fluid 1006 and rises from the liquid region and leaves the vessel 1004, e.g., as syn-gas through a syngas output 1018. Fluid ladened with carbon is removed from the bottom of the vessel, which may have a funnel bottom so as to facilitate gathering the carbon (such as shown in FIGS. 14 and 15). The removed fluid is then filtered, decanted, centrifuged, and/or subjected to other methods for the removal of carbon solids from the liquid, such as through carbon/liquid separator 1020. The excess hydrocarbon fluid is returned to the vessel 1004 through, for example, a pump 1026 that pumps the liquid from the carbon/liquid separator 1020 into liquid return inlet 1022. The liquid returned through the return inlet 1022 includes the filtered liquid hydrocarbon recycled back from the carbon/liquid separator (filter) device 1020.

The cathode 1010 is one side of the high voltage/high current supply that creates the discharge plasma discharge 1012, where decomposition occurs. The syngas output 1018 facilitates the exit for gases that are created in the reactor 1002, including hydrogen gas in space 1016. The anode 1008 is on the other side of the high voltage/high current supply for the discharge plasma 1012, and can be a configured as a rotating drum. This drum can be immersed in a liquid hydrocarbon 1006 where the liquid, due to surface friction and viscosity is drawn up on the drum in a layer 1014, as previously described. During processing and operation of the reactor 1002, carbon solids 1028 are formed and captured by the liquid 1006. The pump 1026 removes liquid from the reactor 1002, e.g., at a constant rate (predetermined by decomposition rate experimentally) during which process the liquid is passed through a separator or filter 1020. The separated carbon exits the separator/filter in a concentrated form and may be sent for further processing. The pump 1026 may then return the filtered liquid via the liquid return 1022 back to the reactor 1002 for reprocessing. Fresh fluid also enters the vessel 1004 through a fresh fluid inlet 1024 configured to keep the level of fluid within the vessel 1004 reasonably constant.

As used, referenced, described or otherwise disclosed in this application, liquid hydrocarbons may include, but are not limited to, oils, waste oils, glycerin, vegetable oils, refinery by-products, asphalts, and other hydrocarbons.

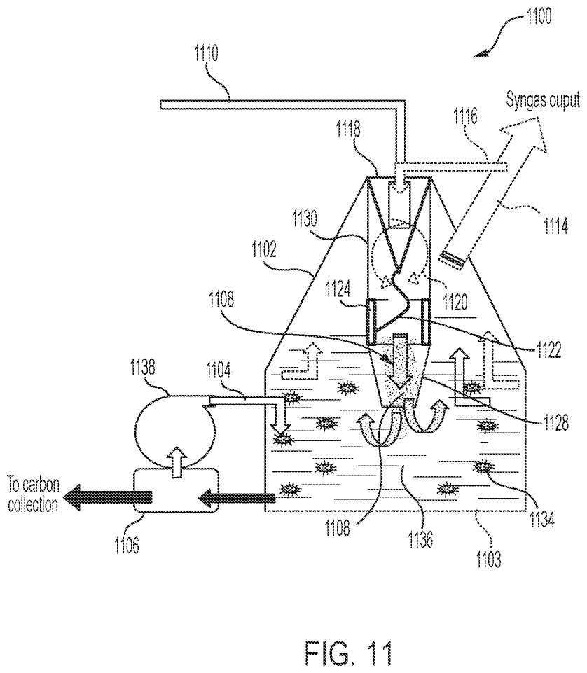

FIG. 11 shows a hydrocarbon disassociation system 1100 according to an embodiment. As shown in FIG. 11, the system 1100 has a liquid reactor 1102 including a vessel 1103, where in some embodiments, the entire vessel 1103 encompasses all or most of the components of the reactor 1102. The input liquid to be processed may enter the vessel 1103 at the liquid return 1104. This liquid return 1104 may include the filtered liquid hydrocarbon recycled back from the carbon/liquid separator (filter) device 1106.

The reactor 1102 may be configured to generate a high enthalpy plasma jet stream 1108 through use of an input gas, such as natural gas feedstock 1110. The gas used for this plasma jet 1108 formation may also include a portion of the syn-gas generated by the reactor device (e.g., fed back through gas return 1116 via syngas output 1114). The gas used for this plasma jet 1108 formation may be all syn-gas, or a mixture of fresh input feedstock gas, for example, but not limited to methane and the syn-gas. Ranges of each gas component could include, for example, methane of 50% with hydrogen of 25% and carbon dioxide of 25% to methane of 98% with hydrogen of 1% and carbon dioxide of 1%. The resulting decomposition of such gas mixtures is all of the carbon dioxide and hydrogen passes through the decomposition as the percentage that enters, and 99+% of the methane (or any other hydrocarbon) are decomposed into hydrogen and solid carbon. In embodiments, some syngas is output via the syngas outlet 1114, and some syngas gas may be fed back into the reactor via a syngas return inlet 1116.

Gas is injected around and through a cathode 1118 (in the view shown in FIG. 11, a triangular shape pointing down) and the cathode 1118 is configured such that the gas exits the cathode in a vortex. The spinning or rotating gas 1120 is met with a DC discharge 1122, which is spinning or rotating in the opposite direction maximizing decomposition rate and efficiency, and generating a high enthalpy plasma jet stream. In an embodiment, the anode 1124 is a magnet which may be a permanent magnet, or a coil or coils wrapped around the reactor 1102 that can induce a magnetic field when electric current is applied through the coil or coils, and is provided to help control and otherwise regulate the rotation of the plasma.

The plasma-forming gas expands and is forced out the bottom nozzle 1128 as plasma 1108, into the fluid 1136 where it transfers all the plasma heat into decomposing the local fluid around the nozzle 1128, thereby generating hydrogen, syn-gas, and carbon solid. That is, due to the heat of the plasma 1108 as it exits nozzle 1128, fluid or liquid 1136 that is in the region of the nozzle 1128 will heat up and decompose into its constituent elements, and this results in hydrogen, syn-gas, and carbon solid. As shown, the level of the fluid 1136 is above the nozzle 1128, such that the plasma 1108 as it exits nozzle 1128 immediately comes into contact with the fluid or liquid 1136 that is in the region of the nozzle 1128. The heated gases bubble up and around the nozzle 1128 and exit the vessel via syngas output 1114 to be purified.

In an embodiment, reactor 1102 includes a discharge plasma reactor 1130, within which a hot gas stream (or plasma jet) 1108 is generated that is aimed at and passes into the liquid 1136 through the nozzle 1128. As described above, as the plasma jet stream 1008 passes into the liquid 1136, it imparts heat energy that results in decomposition of the hydrocarbons in the liquid 1136. There is a natural gas feedstock 1110 that brings gas to the discharge plasma reactor 1130 in order to create the hot plasma jet 1108.

The cathode 1118 side of the high voltage/high current reactor device is shown in a triangle shape in FIG. 11, but the shape is not limited and may be any appropriate shape. The cathode 1118 is one side of the high voltage/high current supply that creates the plasma discharge, where decomposition occurs. The syngas output 1114 is the exit for all gases, including hydrogen, that are created by the reactor shown in FIG. 11. In an embodiment, there is an additional amount of syngas return (e.g., a given percentage of the exiting gas) which can provide a way to recycle filtered by-pass gas from the syngas output 1114 where the desired hydrogen from the decomposition is filtered.

The anode 1124 is the other side of the high voltage/high current supply for the discharge plasma 1122, driving its movement for the decomposition of the feedstock gas fed into the hot plasma jet. The discharge plasma 1122 may move as indicated schematically by the curved line depicting plasma 1122 in FIG. 11. As the plasma exits the nozzle 1128, it flows into the liquid 1136, such as schematically illustrated by the curved arrows below nozzle 1128. Nozzle 1128 concentrates the plasma jet into the liquid for decomposition heat. During processing, carbon solids 1134 are formed and shown captured by the liquid 1136 as the black particles. The pump 1138 removes liquid from the reactor, e.g., at a constant rate (predetermined by decomposition rate experimentally) during which the liquid is passed through a filter 1106. After filter 1106, the carbon has been concentrated and may be sent for further processing. The pump 1138 may return the filtered liquid via the liquid return 1104 back to the reactor for reprocessing.

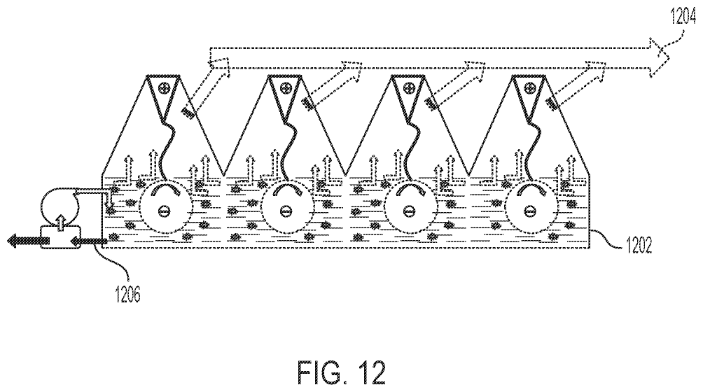

FIG. 12 shows additional embodiments where the processing vessels 1202, as shown and described herein, including in connection with FIGS. 10 and 11, are modular in design, and can be clustered together to increase the total hydrogen/syn-gas output per unit area. The number of units in a cluster is not limited, but may in practice be practically limited by the output requirements for such a facility. This arrangement also allows for utilizing the economy of scale for a larger single syn-gas purification device, and a singular fluid/solid carbon removal (filter/decanter/centrifuge) device. As shown, he individual syngas outputs of each module connect to a common syngas output 1204. Similarly, the modules share a common carbon output 1206. In some embodiments, the vessels may have a sloping or funnel-shaped bottom of each modular unit, e.g., in order to facilitate gathering of the carbon solids. Such modules may also be clustered together in multiple dimensions (e.g., in a matrix-like arrangement), so as to create an even larger liquid pool device. This, again, would allow for economies of scale for other common use devices to be used to reduce processing costs and facility size.

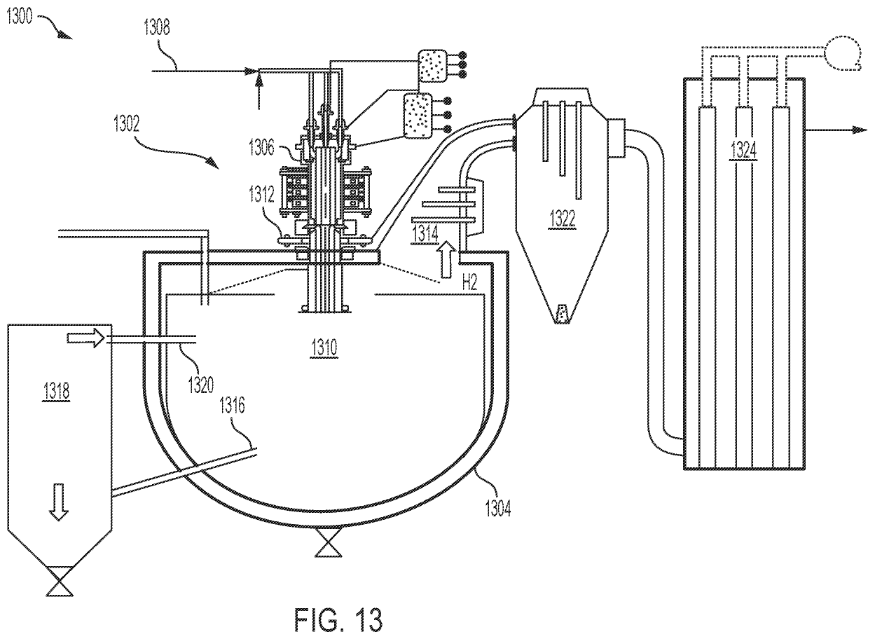

FIG. 13 shows a cross-section of an embodiment similar to the one shown and described with respect to FIG. 11, where the plasma reactor is in intimate contact with the fluid in the vessel. As shown in FIG. 13, hydrocarbon disassociation system 1300 includes a reactor 1302 having a vessel 1304 and further containing one or more of: (i) a plasma source 1306 (e.g., a DC plasma reactor); (ii) an input of natural gas (or other hydrocarbon based) feedstock 1308 which is the hydrocarbon of choice to be dissociated into the high-temperature, high-energy plasma jet generated by reactor 1302 and that is directed into the liquid pool 1310 of hydrocarbons to be decomposed; (iii) a magnet which is incorporated into the anode 1312 of the DC plasma reactor 1306, and is enhancing the DC discharge rotation around the inside of the discharge plasma in such a way as to dissociate all of the natural gas; (iv) a hydrogen (H₂) exit 1314 where the gas produced by the decomposition is channeled for cooling and purification; and (v) a carbon exit 1316, e.g., at the lower left where the now carbon-laden liquid is pumped through an oil filtration separator 1318, which returns the now filtered oil back to the liquid pool 1310 via oil return 1320 for continued processing.

The reactor 1302 can include a cylindrical vessel 1304, e.g., made of a dielectric material or steel, that contains the plasma and provides the liquid pool, the natural gas multi-port injection, the oil filtration, the H₂ exit to a gas cooling station 1322. Gas cooling station 1322 may include a carbon collection zone at a bottom of the station (e.g., a cyclone-type particle separator for dust and particulates) which leads to the separation and purification module 1324. In embodiments, the reactor may be elongated, and a ratio of diameter to length may be from about 2:1 to 10:1.

FIG. 14 shows an iso-tilted section of an approximation of an embodiment similar to the configuration in FIG. 10 where the cathode is positioned over an anode in the form of a rotating drum semi-wetted by the fluid in the vessel where the DC discharge goes directly from the cathode to the anode drum partially embedded in fluid. As shown in FIG. 14, a carbon graphite rod 1401 as plasma source cathode electrode is installed perpendicular to the vessel top; 1402—Hydrogen exhaust is the pipe emanating from the upper right at about a 45 degree angle; 1403—Rotating drum anode that spans the width of the vessel and that is wetted with the hydrocarbon liquid and where the plasma discharge will be dissociating the hydrocarbon into hydrogen and solid carbon; 1404—Is the anode Drum rotating gear motor controllable to 0 to 100 revolutions per minute; 1405—Rotating drum wetting liquid level (and also the upper portion of the 1406 Vessel that is removable for maintenance) held constant such that the top of the drum is extended above the liquid level; 1406—Carbon & hydrocarbon vessel and bottom funnel; 1407—Carbon-dense pump in the center bottom of the sketch is where the carbon-laden liquids are moved to filtration; 1408 and 1409—Solid Carbon removal is depicted by this feature but maybe a filter, a centrifugal device, a decanting tank, or other solid-in-liquid separation method; 1408—in the lower left, indicates the separated carbon exit to further processing, and 1410—Filtered hydrocarbon liquid return in the center left as the flow of this oil for recycling.

FIG. 15 is a wire diagram utilizing a CAD revision of a cross-section of an approximation of the ‘as built’ implementation of an embodiment similar to that shown in FIGS. 11 and 13, with the processing vessel with plasma reactor on top but positioned in intimate positioning with the fluid level in the vessel in such a way as to inject the high temperature plasma jet into the fluid. Processing vessel with Plasma Reactor on top but positioned in intimate position with the fluid level in the vessel in such a way as to inject the high temperature plasma jet into the fluid. 1501—Plasma source reactor (also the DC Plasma reactor in FIG. 13 and discharge plasma reactor in FIG. 11); 1502—Hydrogen exhaust (also the H₂ in FIG. 13 and the Syngas output of FIG. 11); 1503—Hot Plasma gas jetting level into the liquid, which is also the oil fill liquid leveler of FIG. 13; 1504—Hydrocarbon vessel, which is the vessel in FIG. 11 and the reactor containment in FIG. 13; 1505—Liquid level held at this point (not shown in FIG. 11, but shown as Oil fill liquid leveler in FIG. 13); 1506—Carbon & hydrocarbon liquid funnel in the bottom where the oil is removed for filtration; 1507—Carbon-dense pump which is the Oil Filtration in FIG. 13 and the Carbon/liquid separator in FIG. 11; 1508—Solid Carbon removal in the lower left is the carbon exit where it will be further processed; 1509—Filter representation; 1510—Filtered hydrocarbon liquid return.

In some embodiments, the formation of carbon is stopped by the direct contact with liquid feedstock. This quenching of the carbon formation process will dictate the characteristics of the carbon black formed, and therefore its marketability.

The reactor will be cooled, for example, by a water-cooling system that is coupled to the reactor, not shown in these figures. In operation, DC power is supplied to the cathode and anode to create a plasma. Hydrocarbon containing gas is introduced into gas input at the top and enters into a processing zone in reactor at an angle via an angular opening (such as gas exit 806 shown in FIG. 8C).

In some embodiments, RF power may also be supplied to the cathode and anode to create a plasma, e.g., concurrent with the creation of the DC based plasma. Ideally, the hydrocarbon containing gas is pure, or substantially pure, hydrocarbon; in practice, there will be impurities that need to be filtered out. Further, there may be a single hydrocarbon containing gas, or a mixture of different hydrocarbon containing gasses (e.g., methane and natural gas).

The gas flow of the hydrocarbon containing gas pushes the hydrocarbon containing gas into the plasma processing zone. Due to the discharge of high energy plasma, hydrocarbon containing gas passing through this zone is struck with the high energy and disassociates, at very high efficiency, breaking the carbon-hydrogen bonds in the hydrocarbon into singular hydrogen and carbon atoms, i.e., the elemental constituents of the hydrocarbon. In this zone, the hydrocarbon containing gas is heated to a temperature in the range between 1,000° C. to 2,000° C., and in embodiments around 1,500° C., causing a majority or a substantial majority of the hydrocarbon to convert into its elemental constituents.

For example, in embodiments, over 90% of the hydrocarbon containing gas is disassociated, in other embodiments, over 95% dissociation is achieved, in other embodiments over 98% is achieved, and in other embodiments substantially 100% (e.g., 99.99%) is achieved. Operational parameters, like but not limited to, plasma gas feed flow rate that is slower than experimentally nominal values combined with higher voltage and current values applied to the cathode and anode will result in the higher/highest hydrocarbon conversion rate (disassociation rate) into hydrogen, just not at the highest productivity rates. Higher flow rates and lower voltages will lower the percent conversion, but will produce hydrogen at higher rates. Actual parameters are based upon the power size and range of the plasma generator, along with the desired product characteristics to maximize; hydrogen specific, or carbon specific.

As per illustrated in FIG. 10, the discharge plasma is then occurring from the cathode to the rotating anode drum through the thin film evaporating it instantly at the highest temperature possible. The discharge is oscillated/scanned across the top of the rotating drum as to maximize the volume of exposed liquid, there for generating hydrogen.

In FIG. 11, a plasma flame is generated in the reactor just above the liquid level, and this high temperature/high velocity gas blows into the liquid imparting dissociation energy creating hydrogen as a gas and carbon as a solid wetted by the liquid. This carbon is filtered from the liquid by recirculating filtration.

Advantages of systems disclosed herein is that they generally require less energy to decompose hydrocarbons, almost all energy put into plasma goes into disassociation process, and therefore the system is much more efficient. In some embodiments, systems may achieve an efficiency of about 24 kWh/Kg, and in some embodiments, the efficiency may be from about 15 kWh/Kg to about 30 kWh/Kg. Prior art systems are significantly less efficient.

The following applies generally to any hydrocarbon disassociation system disclosed herein, including hydrocarbon disassociation systems. Cathode may optionally be capable of moving. Through use, the material of cathode deteriorates and is etched away, thereby growing smaller over time. By controlling the location of cathode, for example, to maintain a fixed distance between cathode and anode. This can improve the operation of the system over time, and increase the time of continuous operation before cathode must be replaced. A dynamic cathode positioner is further described herein. In another embodiment, the inserted cathode can be configured to have an additional cathode screwed onto the trailing end of the first cathode increasing the total usable life.

Exemplary hydrocarbon-containing gases used in embodiments disclosed herein include methane, natural gas, compressed natural gas (CNG), petroleum gas, syn-gas, bio-diesel, and other types of hydrocarbon including combinations of any of these.

In some embodiments, the target temperature to disassociate hydrocarbon-containing gas is about 1,500° C., and may be from about 1,000° C.-2,000° C. At this temperature, or within this range, the hydrocarbon may be disassociated at a high rate (e.g., more than 98% of hydrocarbon is disassociated), with efficient energy use. The disassociation may still be successful at higher temperatures (e.g., greater than 2,000° C.), but the additional energy to reach those temperatures is effectively “wasted,” in that the disassociation is not substantially improved relative to the additional energy used.

A reactor system could include a single reactor or a plurality of parallel reactors, of the same or different types. In other words, the hydrocarbon disassociation systems disclosed herein are modular.

The hydrocarbon disassociation systems disclosed herein may be used in a variety of applications. Examples of such application could be, but not limited to, light oils like vegetable cooking oils, alcohols, acetone, kerosene, methanol, to fuels like diesel and gasoline, to heavy fluids like crude, waste crankcase oils, and transmission fluids, to semi-solids like asphalt where the feedstock would need to be pre-heated to flow into the vessel.

Plasma source/reactor may include a direct current (DC) discharge plasma source, as shown in FIGS. 10, 11, 12, and 13. The DC discharge plasma source includes a cathode and anode. Cathode and anode may take different shapes including cylindrical, conical, ring shaped, and other geometric configurations. Exemplary materials for cathode and anode include lithium cobalt oxide (LCO), lithium nickel manganese cobalt oxide (NMC), lithium nickel cobalt oxide doped with alumina (NCA), lithium manganese oxide (LMO), and lithium iron phosphate (LFP).

The DC discharge plasma source also includes a power source, such as a DC power source. A plasma discharge is created when DC power is applied to cathode and anode in the presence of a hydrocarbon containing gas, and the plasma discharge occurs between the cathode and anode. In some embodiments, the plasma source may further include a radio frequency (RF) power source that can create an RF-based plasma between cathode and anode. While the DC-based plasma is a discharge, if a RF-based plasma is used, it will expand to fill the volume of the reactor within the plasma processing zone.

Hydrogen/Syngas output is provided to allow the gaseous hydrogen to be collected. For example, hydrogen exit may include a valve and piping allowing the hydrogen to exit the hydrocarbon disassociation system. The exiting hydrogen may include some amount of hydrocarbon gas and/or other impurities, and may be subject to further purification processes. In some embodiments, remaining hydrocarbon gas may be recycled back to the reactor, for example by pressure already supplied by the purification compressor or by venture into the plasma gas feedstock supply.

Carbon exit (shown as Carbon/liquid separator), as shown in each drawing at the lower left is provided to allow the solid carbon to be filtered from the feedstock liquid and collected. From this filtered collection, carbon with some fluid will be transferred to a rotary no oxygen pyrolysis kiln operating at about 800 deg C where the fluid is evaporated as a syn-gas and returned to the plasma reactor for conversion, and the dried carbon is now carbon black, and packaged for sale or further processing.

FIG. 12 illustrates a multitude of liquid hydrocarbon disassociation systems utilizing a rotating drum-creating-liquid film device as a method to combine fluid holding vessels, fluid filtering requirements, cooling requirements, and gaseous filtration and purification requirements according to an embodiment.

The process disclosed herein may run on a continuous basis with little or no interruption, which minimizes downtime impact from maintenance. Allowing the process to stabilize and operate at favorable nominal process parameters leads to more consistent product quality. One of the few maintenance interrupts for the disclosed process is the replacement of high temperature cathode in the reactor. Due to the etching effects from the high current on cathode, which may be made of graphite or graphite composites, for example, and made at desirable dimensions specifically to extend its useful lifetime, cathode will erode over time and must be replaced. In some embodiments, the cathode is positioned relative to the anode to regulate the size and potency of the plasma energy, and in embodiments this dimensional feature is within approximately +/−10% of a predetermined value.

In embodiments a sensor (e.g., a Methane gas detector from Honeywell Co.) may be used to measure the amount of hydrocarbon containing gas that leaves the reactor through either of the hydrogen exit and carbon exit and/or that measures the amount of hydrocarbon containing gas that passes through the gas/solid separating zone or in the syn-gas output/hydrogen exhaust (702), as noted in the FIGS. 11, 12, 15 and 16. A sensor may also be used to measure the amount of hydrocarbon containing gas entering the reactor through input. From these measurements, the amount of hydrocarbon containing gas that is disassociated may be determined. If the amount is too low (e.g., less than 98%), then a control circuit coupled to the DC power supply may alter the current flow, rotation speed, and other processing-controlled parameters so as to cause the plasma to rotate at a faster rate, with the effect of holding the conversion rate at a high constant.

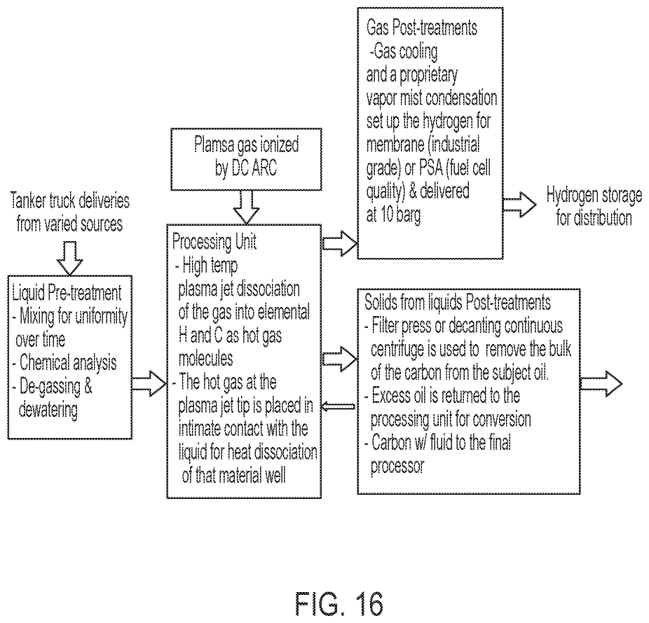

FIG. 16 illustrates a process flow as a block diagram for the liquid decomposition according to an embodiment. In this embodiment, tankers or other carrying vehicles deliver oils, lubricants, and other types of liquids (including, but not limited to, unwanted and waste liquids), which are temporarily stored. Liquid pre-treatment is performed during storage and prior to use which includes chemical analyses, mixing for uniformity, de-gassing, and de-watering. Since the liquids will be obtained from different supplies and stored for pre-processing in different tankage, and therefore assumed to be of different chemicals and concentration of said chemicals, an analysis may be required to determine the mixing portions of the different liquids together as ingredients to form an acceptable processable feedstock. A pre-determined mixture chart may assist in this process to get a relatively decomposition rate, uniform flow of hydrogen, consistency of heating, and carbon/hydrogen ratio. This ratio will establish the processing parameters previously determined by experimental results for best hydrogen conversion and purity. While the fluid is waiting, de-gassing and de-watering pretreatment (indirect heating to >100 deg C and <150 deg C) is administered. The fluid is then mixed in-transit to the processor, and since it will be warm from pretreatment, the flow into the reactor is achievable with low-energy liquid pumping. Processing occurs instantly as natural gas (or syn-gas) as an ionized plasma gas dumps all its plasma energy into the liquid, generating hydrogen in gas form, carbon particles in the liquid, and a host of other hydrocarbon gas vapors. An optional direct discharge to liquid method of decomposition is also described herein. The gas then moves without contact or dilution with outside air, to the cooling and condensing unit. This equipment reduces the hydrogen temperature to below hydrocarbon vapor condensation temperatures. The condensed vapors are return to the vessel liquid pool for reprocessing, and the hydrogen moves to membrane or PSA contaminate removal. This then results in a 99 to 99.99% (if woven or PSA processed, respectfully) quality hydrogen suitable for industrial or fuel cell use, respectfully. Clean hydrogen is pumped at >10 bar to a storage tank. Further pressurizing and/or pressured transfer to delivery truck-age or rail car maybe required and accomplished at additionally pumped/compressed pressures of 170 to 350 bar, or in some embodiments, to 500 bar. The oil is collecting the carbon generated. This carbon builds up and settles in the bottom of the vessel. The high-density carbon settles to the bottom of the vessel and is slowly pumped to the filtering mechanism. Excess oil extracted here goes back for reprocessing by pouring back into the constant level liquid of the vessel. The collected carbon is moved to the final processor, which may be a top loading plasma reactor where the carbon mass is subjected to a ‘drop-in’ decomposition and hydrogen and carbon black are made, similar to the gas processing units. In some embodiments, the collected carbon may be processed via a pyrolytic plasma/syngas heated decomposition kiln, reducing the oily carbon to hydrogen and carbon black.

The hydrocarbon disassociation systems disclosed herein may be used in a variety of applications. For example, Hydrocarbon disassociation may be useful when handling natural gas, such as liquefied natural gas (LNG). Source facilities liquefy natural gas into LNG, which can then be transported on a ship specially designed to carry LNG from a source facility to a receiving facility. Typically, LNG is transported from the oil and gas fields where it is drilled up and liquefied. This liquid is then transported on a ship to the customer location, since it is a higher energy density than hydrogen. From there, it is either re-gasified (which is only a change of physical phase from liquid to gas) and then pumped on-shore to storage tanks, or pumped onshore as the same liquid state it was transported as. This is only a change of physical state, not a conversion to a different chemical compound, what we call a conversion in this application.

This ship may have three main processing components on it. First, there may be a regasification processor, such as a regasification processor known in the industry. This regasification will be sized to address the natural gas volume expected to be processed per day and the natural gas electrical generator needs of power for the process and its associated equipment. Second, there may be a smaller and more limited volume of LNG storage held on this ship with enough volume to address a certain number of days of power generation by natural gas generators onboard and for the feedstock supply gas. Third, the ship may have the conversion reactors (i.e., the hydrocarbon disassociation systems described herein) creating and storing hydrogen from the hydrocarbon feedstock.

In embodiments, these ships may include a hydrocarbon disassociation system, such as system 100 or system 200. For example, a ship may have reactors of various sizes, e.g., 5 to 10 mega-watt reactors, which can generate high quality hydrogen. The ship may move to a receiving location where it receives LNG. A portion of the LNG may be transferred to a regasification processor where re- gasification occurs. Re-gasification of the LNG will occur as required, with some margin for surge capacity. If dehumidification is required, this will happen here to insure a high-quality raw material source for the process and now gaseous NG will be utilized for power generation. As a result of this re-gasification, power is generated, exhaust gases may be utilized for heating (e.g., as needed for re-gasification), and cooled exhaust gases may be vented. In addition, or alternatively, natural gas (or other feedstock gas) may be converted by the hydrocarbon disassociation system onboard the ship to hydrogen, which can be stored and pumped to a receiving facility. Additionally, the conversion of natural gas to hydrogen may also produce carbon, and the carbon may be packaged and transferred to the same receiving facility, a different receiving facility, or dumped as an inert solid without negative environmental impact.

Aspects of the present disclosure are further described by the following non-limiting list of items:
Item 1. A method for producing hydrogen and carbon from hydrocarbons in a reaction chamber, the method comprising:
introducing a hydrocarbon into a chamber such that the hydrocarbon rotates in a first direction;
generating a direct current (DC)-based plasma from a portion of the hydrocarbon, wherein the hydrocarbon is heated to a temperature greater than 1,000° C. at least in part by the DC-based plasma;
rotating the DC-based plasma in a second direction that is different from the first direction;
converting the hydrocarbon into elemental constituents of the hydrocarbon comprising carbon solid and hydrogen gas; and separating the carbon solid from the hydrogen gas to provide a solid part and a gas part.
Item 2. The method of item 1, wherein the second direction opposes the first direction.
Item 3. The method of any one of item 1-2, further comprising quenching the carbon solid, wherein the carbon solid comprises carbon black.
Item 4. The method of any one of items 1-3, wherein a portion of the plasma and a portion of the hydrocarbon come into angular contact with one another based on their respective rotations being different in one or more dimensions.
Item 5. The method of any one of item 1-4, wherein the hydrocarbon is contained in a gas that is substantially devoid of oxygen, nitrogen, and sulfurs.
Item 6. The method of any one of item 1-4, wherein the amount of oxygen, nitrogen, and sulfurs in the gas is less than one molar percent.
Item 7. The method of any one of items 1-6, further comprising generating a radio-frequency (RF) based plasma.
Item 8. The method of any one of items 1-7, wherein separating the carbon solid from the hydrogen gas comprises removing the carbon solid via a fluid cooled auger in such a way as to restrict the reintroduction of air into the carbon solid within the separation chamber.
Item 9. The method of any one of items 1-8, wherein the hydrocarbon is heated to a temperature between 1,400° C.-2,000° C.
Item 10. The method of any one of items 1-9, wherein separating the carbon solid from the hydrogen gas further comprises one or more of:
reducing the gas velocity by placing the carbon solid and hydrogen gas into a volumetrically larger section of the reaction chamber and allowing gravity to let the carbon solid settle;
reducing the temperature by allowing the carbon solid and/or hydrogen gas to contact walls of the reaction chamber, therefore reducing the gas volume and velocity; and
contacting the carbon solid and/or hydrogen gas to the walls, thereby physically slowing the carbon solid so that it can collect and fall to the bottom of the reaction chamber.
Item 11. An apparatus for producing hydrogen and carbon solid from gaseous hydrocarbons, the apparatus comprising:
a processing chamber having a gas input, a gas outlet, and a solid outlet;
a direct current (DC) plasma generator configured to generate a plasma within a plasma-processing zone of the processing chamber, wherein the DC plasma generator includes a cathode and anode within the processing chamber and wherein the DC plasma generator is configured so that the plasma heats up gas passing through the plasma processing zone to a temperature greater than 1,000° C. causing hydrocarbons in the gas to disassociate;
a magnet external to the processing chamber configured to cause plasma generated by the DC plasma generator to rotate; and
a cooling system within a separating zone of the processing chamber, wherein the gas input is configured to cause gas that passes through the gas input to rotate.
Item 12. The apparatus of item 11, wherein the cathode is moveable, and the apparatus further includes a control system configured to move the cathode so as to maintain a predetermined distance between the anode and cathode.
Item 13. The apparatus of any one of items 11-12, further comprising a fluid cooled auger configured for removing solid carbon from the processing chamber.
Item 14. The apparatus of any one of items 11-13, wherein the magnet external to the processing chamber is configured to cause plasma generated by the DC plasma generator to rotate at a rate between 1,000 RPM and 6,000 RPM.
Item 15. The apparatus of any one of items 11-14, further comprising a radio frequency (RF) plasma generator configured to generate a plasma within the plasma processing zone of the processing chamber.
Item 16. The apparatus of any one of items 11-15, wherein the magnet external to the processing chamber configured to cause plasma generated by the DC plasma generator to rotate is further configured to cause the plasma generated by the DC plasma generator to rotate in a direction opposite the direction of rotation of the gas passing through the gas input.
Item 17. An apparatus for producing hydrogen and carbon solid from gaseous hydrocarbons, the apparatus comprising:
a processing chamber having a gas input, a gas outlet, and a solid outlet;
a plasma generator configured to generate a plasma within a plasma-processing zone of the processing chamber and wherein the DC plasma generator is configured so that the plasma heats up gas passing through the plasma processing zone to a temperature greater than 1,400° causing hydrocarbons in the gas to disassociate;
a magnet external to the processing chamber configured to cause plasma generated by the DC plasma generator to rotate; and
a cooling system within a separating zone of the processing chamber; wherein the cooling system is capable of reducing a gas temperature to about 500° C. or less so as to stop carbon black particle, aggregate, and agglomerate formation.
Item 18. An apparatus for producing hydrogen and carbon solid from gaseous hydrocarbons, the apparatus comprising:
a processing chamber having a gas input, a gas outlet, and a solid outlet;
a plasma generator configured to generate a plasma within a plasma-processing zone of the processing chamber and wherein the DC plasma generator is configured so that the plasma heats up gas passing through the plasma processing zone to a temperature greater than 1,400° causing hydrocarbons in the gas to disassociate;
a magnet external to the processing chamber configured to cause plasma generated by the DC plasma generator to rotate; and
a cooling system within a separating zone of the processing chamber; wherein the cooling system is capable of reducing a gas temperature to about 1000° C. or less so as to stop carbon black particle, aggregate, and agglomerate formation.
Item 19. The apparatus of any one of items 17-18, wherein the cooling system comprises a plurality of gas injection nozzles circumferentially arranged around a part of the reaction chamber downstream from the anode, wherein the gas injection nozzles are coupled to a source of hydrogen gas that is allowed to pass through the gas injection nozzles creating a curtain of cooling gas that the gas passing out of the plasma processing zone must pass through.
Item 20. The apparatus of item 19, wherein the source of hydrogen gas is a small portion of pressurized hydrogen gas from a purification system coupled to the gas outlet.
Item 21. A method for producing hydrogen and carbon solid from liquid hydrocarbons, the method comprising:
introducing liquid hydrocarbons to a processing vessel;
introducing a plasma-forming gas;
forming or maintaining a DC plasma discharge between a cathode and an anode based at least in part on the plasma-forming gas, wherein the anode is rotatable and is at least partially submerged in the liquid hydrocarbons;
rotating the anode to form a liquid film covering the anode, so that hydrocarbons in the liquid film are heated by the DC plasma discharge to a temperature in the range between 1500 degrees K and 6000 degrees K thereby converting at least part of the hydrocarbons in the liquid film into elemental constituents;
cooling the constituents to form a gas and solid product mixture comprising hydrogen gas and carbon solid; and extracting the hydrogen gas and carbon solid product mixture.
Item 22. The method of item 21, wherein the hydrogen gas in the hydrogen gas and carbon solid product mixture is in syngas, and extracting the hydrogen gas and carbon solid product mixture comprises separating hydrogen from other components of the syngas.
Item 23. The method of any one of items 21-22, wherein extracting the hydrogen gas and solid product mixture comprises:
allowing the hydrogen gas in the hydrogen gas and solid product mixture to exit through a gas output;
allowing the carbon solid in the hydrogen gas and solid product mixture to exit through a carbon output; and
separating carbon solid from liquid in the carbon output.
Item 24. The method of item 23, wherein the gas output is located above a predetermined level of liquid in the processing vessel and the carbon output is located below the predetermined level of liquid in the processing vessel.
Item 25. The method of any one of items 21-24, wherein separating carbon solid from liquid in the carbon output comprises using a filter.
Item 26. The method of any one of items 21-25, wherein liquid that is separated from carbon solid in the carbon output is returned back into the processing vessel.
Item 27. The method of any one of items 21-26, further comprising separating vapor-laden H₂ gas having a vapor content above a threshold from the H₂ gas in the gas output and returning condensed liquid from the vapor-laden H₂ gas back into the processing vessel.
Item 28. The method of any one of items 21-27, wherein the processing vessel is sealed such that no atmospheric gases are able to enter above a level of liquid in the processing vessel.
Item 29. The method of any one of items 21-28, wherein introducing a plasma-forming gas comprises converting part of the liquid hydrocarbons to gas and solids.
Item 30. The method of any one of items 21-29, further comprising controlling a level of liquid in the processing vessel to maintain the level of liquid at a predetermined level.
Item 31. The method of any one of items 21-30, wherein the anode comprises a drum.
Item 32. The method of any one of items 21-31, further comprising: prior to introducing liquid hydrocarbons to the processing vessel, pre-treating the liquid hydrocarbons to remove one or more of trapped gases, water, and light hydrocarbons.
Item 33. A system for producing hydrogen and carbon solid from liquid hydrocarbons, the system comprising:
a processing vessel having a first region for containing gas and a second region for containing liquid hydrocarbons;
a cathode and an anode for forming or maintaining a DC plasma discharge between the cathode and the anode, wherein the anode is rotatable;
a gas output in the first region;
a carbon output in the second region;
a liquid input in the second region for introducing liquid hydrocarbons to the processing vessel; and
a power source coupled to the anode and the cathode.
Item 34. The system of item 33, wherein the carbon output comprises a filter.
Item 35. The system of item 34, further comprising a liquid return and a pump coupled to the filter and the liquid return configured to reintroduce liquid from the carbon output back into the processing vessel.
Item 36. The system of any one of items 33-35, further comprising a gas input and a gas separation device coupled to the gas output and the gas input, wherein the gas separation device is configured to separate pure hydrogen from other gas and further configured to reintroduce the separated other gas back into the processing vessel.
Item 37. The system of any one of items 33-36, wherein the processing vessel is sealed such that no atmospheric gases are able to enter above a level of liquid in the processing vessel.
Item 38. The system of any one of items 33-37, further comprising a controller coupled to one or more of the liquid input and carbon output and configured to control a level of liquid in the processing vessel to maintain the level of liquid at a predetermined level.
Item 39. The system of any one of items 33-38, wherein the anode comprises a drum.
Item 40. A system for producing hydrogen and carbon solid from liquid hydrocarbons, the system comprising:
an array of processing vessels, each processing vessel having a first region for containing gas and a second region for containing liquid hydrocarbons;
each processing vessel having a cathode and an anode for forming or maintaining a DC plasma discharge between the cathode and the anode, wherein the anode is rotatable;
each processing vessel having a gas output in the first region;
each processing vessel having a carbon output in the second region;
each processing vessel having a liquid input in the second region for introducing liquid hydrocarbons to the processing vessel; and
each processing vessel having a power source coupled to the anode and the cathode.
Item 41. The system of item 40, wherein the array of processing vessels includes a row of n processing vessels for a number n>1.
Item 42. The system of item 40, wherein the array of processing vessels includes m rows of n processing vessels for a first number n>1 and a second number m>1.
Item 43. The system of any one of items 40-42, wherein the carbon output of one of the processing vessels is shared among two or more of the processing vessels.
Item 44. The system of any one of items 40-42, wherein the carbon output of each of the processing vessels is shared among each of the processing vessels.
Item 45. A method for producing hydrogen and carbon solid from liquid hydrocarbons, the method comprising:
introducing liquid hydrocarbons to a processing vessel;
introducing a plasma-forming gas;
forming or maintaining a plasma between a cathode and an anode based at least in part on the plasma-forming gas;
directing a plasma jet formed from the plasma into the liquid hydrocarbons, so that hydrocarbons in the vicinity of the plasma jet are heated by the plasma jet to a temperature in the range between 1500 degrees K and 6000 degrees K thereby converting at least part of the hydrocarbons in the vicinity of the plasma jet into elemental constituents;
cooling the constituents to form a gas and solid product mixture comprising hydrogen gas and carbon solid; and extracting the gas and solid product mixture.
Item 46. The method of item 45, wherein extracting the gas and solid product mixture comprises:
allowing the hydrogen gas in the gas and solid product mixture to exit through a gas output; allowing the carbon solid in the gas and solid product mixture to exit through a carbon output; and
separating carbon solid from liquid in the carbon output.
Item 47. The method of item 46, wherein the gas output is located above a predetermined level of liquid in the processing vessel and the carbon output is located below the predetermined level of liquid in the processing vessel.
Item 48. The method of any one of items 46-47, wherein separating carbon solid from liquid in the carbon output comprises using a filter.
Item 49. The method of any one of items 46-48, wherein liquid that is separated from carbon solid in the carbon output is returned back into the processing vessel.
Item 50. The method of any one of items 46-49, further comprising separating vapor-laden H₂ gas having a vapor content above a threshold from the H₂ gas in the gas output and returning condensed liquid from the vapor-laden H₂ gas back into the processing vessel.
Item 51. The method of any one of items 46-50, wherein the processing vessel is sealed such that no atmospheric gases are able to enter above a level of liquid in the processing vessel.
Item 52. The method of any one of items 46-51, wherein introducing a plasma-forming gas comprises one or more of (i) feeding a plasma-forming gas from outside the processing vessel into the processing vessel and (ii) returning back a part of the extracted gas.
Item 53. The method of any one of items 46-52, further comprising controlling a level of liquid in the processing vessel to maintain the level of liquid at a predetermined level.
Item 54. A system for producing hydrogen and carbon solid from liquid hydrocarbons, the system comprising:
a processing vessel having a first region for containing gas and a second region for containing liquid hydrocarbons;
a plasma forming reactor having a cathode and an anode for forming or maintaining a plasma between the cathode and the anode and further having a nozzle for directing a plasma jet formed from the plasma into the second region;
a gas output in the first region;
a carbon output in the second region;
a liquid input in the second region for introducing liquid hydrocarbons to the processing vessel; and
a power source coupled to the anode and the cathode.
Item 55. The system of item 54, wherein the carbon output comprises a filter.
Item 56 The system of item 55, further comprising a liquid return and a pump coupled to the filter and the liquid return configured to reintroduce liquid from the carbon output back into the processing vessel.
Item 57. The system of any one of items 54-56, further comprising a gas input and a gas separation device coupled to the gas output and the gas input, wherein the gas separation device is configured to separate pure hydrogen from other gas and further configured to reintroduce the separated other gas back into the processing vessel.
Item 58. The system of any one of items 54-57, wherein the processing vessel is sealed such that no atmospheric gases are able to enter above a level of liquid in the processing vessel.
Item 59. The system of any one of items 54-58, further comprising a controller coupled to one or more of the liquid input and carbon output and configured to control a level of liquid in the processing vessel to maintain the level of liquid at a predetermined level.
Item 60. A system for producing hydrogen and carbon solid from liquid hydrocarbons, the system comprising:
an array of processing vessels, each processing vessel having a first region for containing gas and a second region for containing liquid hydrocarbons;
each processing vessel having a plasma forming reactor having a cathode and an anode for forming or maintaining a plasma between the cathode and the anode and the plasma forming reactor further having a nozzle for directing a plasma jet formed from the plasma into the second region;
each processing vessel having a gas output in the first region;
each processing vessel having a carbon output in the second region;
each processing vessel having a liquid input in the second region for introducing liquid hydrocarbons to the processing vessel; and
each processing vessel having a power source coupled to the anode and the cathode.
Item 61. The system of item 60, wherein the array of processing vessels includes a row of n processing vessels for a number n>1.
Item 62. The system of item 60, wherein the array of processing vessels includes m rows of n processing vessels for a first number n>1 and a second number m>1.
Item 63. The system of any one of items 60-62, wherein the carbon output of one of the processing vessels is shared among two or more of the processing vessels.
   Item 64. The system of any one of items 60-62, wherein the carbon output of each of the processing vessels is shared among each of the processing vessels.

While various embodiments are described herein, it should be understood that they have been presented by way of example only, and not limitation. Thus, the breadth and scope of this disclosure should not be limited by any of the above-described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-17. (canceled)

18. An apparatus for producing hydrogen and carbon solid from gaseous hydrocarbons, the apparatus comprising:
a processing chamber having a gas input, a gas outlet, and a solid outlet;
a plasma generator configured to generate a plasma within a plasma-processing zone of the processing chamber and wherein the DC plasma generator is configured so that the plasma heats up gas passing through the plasma processing zone to a temperature greater than 1,400° causing hydrocarbons in the gas to disassociate;
a magnet external to the processing chamber configured to cause plasma generated by the DC plasma generator to rotate; and
a cooling system within a separating zone of the processing chamber; wherein the cooling system is capable of reducing a gas temperature to about 1000° C. or less so as to stop carbon black particle, aggregate, and agglomerate formation.

19. The apparatus of claim 18, wherein the cooling system comprises a plurality of gas injection nozzles circumferentially arranged around a part of the reaction chamber downstream from the anode, wherein the gas injection nozzles are coupled to a source of hydrogen gas that is allowed to pass through the gas injection nozzles creating a curtain of cooling gas that the gas passing out of the plasma processing zone must pass through.

20. The apparatus of claim 19, wherein the source of hydrogen gas is a small portion of pressurized hydrogen gas from a purification system coupled to the gas outlet.

21. A method for producing syngas and carbon solid from liquid hydrocarbons, the method comprising:
introducing liquid hydrocarbons to a processing vessel;
introducing a plasma-forming gas;
forming or maintaining a DC plasma discharge between a cathode and an anode based at least in part on the plasma-forming gas, wherein the anode is rotatable and is at least partially submerged in the liquid hydrocarbons;
rotating the anode to form a liquid film covering the anode, so that hydrocarbons in the liquid film are heated by the DC plasma discharge to a temperature in the range between 1500 degrees K and 6000 degrees K thereby converting at least part of the hydrocarbons in the liquid film into elemental constituents;
cooling the constituents to form a gas and solid product mixture comprising hydrogen gas and carbon solid; and
extracting the hydrogen containing gas and carbon solid product mixture.

22. The method of claim 21, wherein the hydrogen gas in the hydrogen gas and carbon solid product mixture is in syngas, and extracting the hydrogen gas and carbon solid product mixture comprises separating hydrogen from other components of the syngas.

23. The method of claim 21, wherein extracting the hydrogen gas and solid product mixture comprises:
allowing the hydrogen gas in the hydrogen gas and solid product mixture to exit through a gas output;
allowing the carbon solid in the hydrogen gas and solid product mixture to exit through a carbon output; and
separating carbon solid from liquid in the carbon output.

24. The method of claim 23, wherein the gas output is located above a predetermined level of liquid in the processing vessel and the carbon output is located below the predetermined level of liquid in the processing vessel.

25. The method of claim 21, wherein separating carbon solid from liquid in the carbon output comprises using a filter.

26. The method of claim 21, wherein liquid that is separated from carbon solid in the carbon output is returned back into the processing vessel.

27. The method of claim 21, further comprising separating vapor-laden H₂ gas having a vapor content above a threshold from the H₂ gas in the gas output and returning condensed liquid from the vapor-laden H₂ gas back into the processing vessel.

28. The method of claim 21, wherein the processing vessel is sealed such that no atmospheric gases are able to enter above a level of liquid in the processing vessel.

29. The method of claim 21, wherein introducing a plasma-forming gas comprises converting part of the liquid hydrocarbons to gas and solids.

30. The method of claim 21, further comprising controlling a level of liquid in the processing vessel to maintain the level of liquid at a predetermined level.

31. The method of claim 21, wherein the anode comprises a drum.

32. The method of claim 21, further comprising: prior to introducing liquid hydrocarbons to the processing vessel, pre-treating the liquid hydrocarbons to remove one or more of trapped gases, water, and light hydrocarbons.

33-44. (Canceled)

45. A method for producing syngas and carbon solid from liquid hydrocarbons, the method comprising:
introducing liquid hydrocarbons to a processing vessel;
introducing a plasma-forming gas;
forming or maintaining a plasma between a cathode and an anode based at least in part on the plasma-forming gas;
directing a plasma jet formed from the plasma into the liquid hydrocarbons, so that hydrocarbons in the vicinity of the plasma jet are heated by the plasma jet to a temperature in the range between 1500 degrees K and 6000 degrees K thereby converting at least part of the hydrocarbons in the vicinity of the plasma jet into elemental constituents;
cooling the constituents to form a gas and solid product mixture comprising hydrogen gas and carbon solid; and
extracting the gas and solid product mixture.

46. The method of claim 45, wherein extracting the gas and solid product mixture comprises:
allowing the hydrogen gas in the gas and solid product mixture to exit through a gas output;
allowing the carbon solid in the gas and solid product mixture to exit through a carbon output; and
separating carbon solid from liquid in the carbon output.

47. The method of claim 46, wherein the gas output is located above a predetermined level of liquid in the processing vessel and the carbon output is located below the predetermined level of liquid in the processing vessel.

48. The method of claim 46, wherein separating carbon solid from liquid in the carbon output comprises using a filter.

49. The method of claim 46, wherein liquid that is separated from carbon solid in the carbon output is returned back into the processing vessel.

50-64. (canceled)
